(19) United States
(12) Patent Application Publication
(10) Pub. No.: US 2013/0059991 A1
(43) Pub. Date: Mar. 7, 2013

(54) CATALYST FOR STEREOSELECTIVE OLEFIN POLYMERIZATION AND METHOD FOR MANUFACTURING STEREOSELECTIVE POLYOLEFIN

(71) Applicants: Akihiko Ishii, Saitama (JP); Norio Nakata, Saitama-shi (JP); Tomoyuki Toda, Saitama-shi (JP); Tsukasa Matsuo, Wako-shi (JP)

(72) Inventors: Akihiko Ishii, Saitama (JP); Norio Nakata, Saitama-shi (JP); Tomoyuki Toda, Saitama-shi (JP); Tsukasa Matsuo, Wako-shi (JP)

(73) Assignees: SUMITOMO CHEMICAL COMPANY, LIMITED, Chuo-ku, Tokyo (JP); NATIONAL UNIVERSITY CORPORATION SAITAMA UNIVERSITY, Saitama-shi, Saitama (JP)

(21) Appl. No.: 13/577,933

(22) PCT Filed: Feb. 10, 2011
(86) PCT No.: PCT/JP2011/052937

§ 371 Date: Nov. 19, 2012

(30) Foreign Application Priority Data
Feb. 12, 2010 (JP) 2010-029191

(51) Int. Cl. C07F 7/08; C08F 4/76; C08F 4/642; C08F 136/20; C08F 110/14; C08F 110/06; C08F 110/08; C08F 136/06; C07F 7/00; C08F 4/659

(52) U.S. Cl. 526/170; 556/54; 556/52; 556/56; 556/12; 502/168; 502/155; 502/167; 502/117; 502/158

(57) ABSTRACT

A stereoselective olefin polymerization catalyst contains a complex represented by Formula (1):

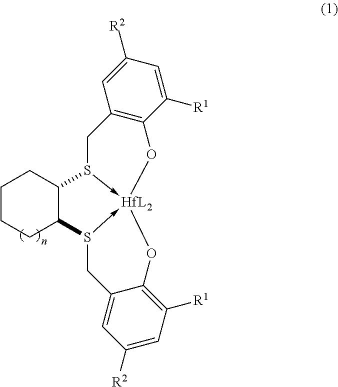

wherein n is 2 or 3; R¹ and R² are independently an optionally substituted alkyl group or a halogen atom; L is a ligand represented by CH₂R³, a halogen atom, OR⁴, or NR⁵R⁶; R³ is a hydrogen atom, an aromatic group, or a trialkylsilyl group; R⁴ is a lower alkyl group having 1 to 6 carbon atoms; and R⁵ and R⁶ are independently a hydrogen atom or a lower alkyl group having 1 to 6 carbon atoms. A method for manufacturing stereoselective polyolefin, includes polymerizing an olefin in the presence of the catalyst. The present invention provides a catalyst which enables highly isoselective polymerization generating a polymer having significantly high molecular weight and also can prepare stereoselective polyolefin with a narrow dispersity (Mw/Mn) or with a sharp molecular weight distribution, and provides a method for manufacturing stereoselective polyolefin with the catalyst.

### CROSS-REFERENCE TO RELATED APPLICATIONS

This application claims priority to Japanese Patent Application No.2010-029191 filed on Feb. 12, 2010 and the entire contents of which are incorporated herein particularly by reference.

### TECHNICAL FIELD

The present invention relates to a catalyst for stereoselective olefin polymerization employing a hafnium complex, and a manufacturing method of a stereoselective polyolefin using the catalyst.

### BACKGROUND ART

In olefin polymerization chemistry which has made significant progress in the wake of a highly active magnesium-supported titanium catalyst of a Ziegler-Natta type, the development of metallocene catalysts is one of the recent topics. Recently, development of so-called post-metallocene catalysts has attracted attention for catalysts to build a more precise polymerization process.

In 2000, Kol et al. developed a zirconium complex having C₂ symmetry using a tetradentate ligand having a phenoxy group and a nitrogen atom and having high affinity for group IV metal elements, and first reported that 1-hexene polymerization reaction catalyzed by this compound proceeds highly isoselectively at room temperature (Non-patent Literatures 1 to 3). Furthermore, Kol (Non-patent Literature 4) and Okuda et al. in Germany (Non-patent Literatures 5 and 6) synthesized group IV metal complexes using a ligand that contains sulfur atoms in place of the nitrogen atoms in the tetradentate ligand in an attempt to achieve a-olefin stereoselective polymerization. However, even though having C₂ symmetry, these complexes failed to achieve the α-olefin stereoselective polymerization reaction. This is probably caused by the loss of the C₂ symmetry of the active center during the reaction due to the structural flexibility of cationic species (catalytically active species in a-olefin polymerization), which are prepared from these complexes with the aid of co-catalysts. Accordingly, it is desired to develop a new ligand and catalyst which exhibit high activity while retaining C₂ symmetry.

Patent Literature 1 discloses a method for polymerization of propylene with a diphenoxytitanium, diphenoxyzirconium or diphenoxyhafnium complex derived from ethane-1,2-dithiol.

The present inventors have reported diphenoxytitanium, diphenoxyzirconium, and diphenoxyhafnium complexes derived from trans-cyclooctane-1,2-dithiol (Non-Patent Literature 7), and a method for polymerization of 1-hexene with the zirconium complex, as a catalyst, among these complexes (Non-Patent Literature 8).

### CITATION LIST

### Non-Patent Literature

Non-Patent Literature 1: Journal of American Chemical Society, 2000, Volume 122, 10706-10707

Non-Patent Literature 2: Journal of American Chemical Society, 2006, Volume 128, 13062-13063

Non-Patent Literature 3: Journal of American Chemical Society, 2008, Volume 130, 2144-2145

Non-Patent Literature 4: Inorganic Chemistry, 2007, Volume 46, 8114-8116

Non-Patent Literature 5: Journal of American Chemical Society, 2003, Volume 125, 4964-4965

Non-Patent Literature 6: Angewandte Chemie International Edition, 2007, Volume 46, 4790-4793

Non-Patent Literature 7: Toda et al. Dai 58 Kai Sakutai Kagaku Touronkai, Kouen Youshishu (Abstract of the 58th Japan Society of Coordination Chemistry Symposium) 1Ab-07, Sep. 20, 2008

Non-Patent Literature 8: Journal of American Chemical Society, 2009, Volume 131, 13566-13567

### Patent Literature

Patent Literature 1: WO2007/075299

The entire contents of Patent Literature 1 and Non-Patent Literatures 1 to 8 are incorporated herein particularly by reference.

### SUMMARY OF THE INVENTION

### Problems to be Solved by the Invention

While the diphenoxy zirconium complex derived from trans-cyclooctane-1,2-dithiol described in Non-Patent Literature 8 enables highly active and highly isoselective polymerization, it is desired to provide a catalyst which generates polymers having higher molecular weight and enables isoselective polymerization, and a method for manufacturing stereoselective polyolefin with the catalyst.

Accordingly, an object of the present invention is to provide a catalyst which enables highly isoselective polymerization generating a polymer having significantly high molecular weight and also can prepare stereoselective polyolefin with a narrow dispersity (Mw/Mn) and with a sharp molecular weight distribution, compared with the diphenoxy zirconium complex derived from trans-cyclooctane-1,2-dithiol described in Non-Patent literature 8, and a method for manufacturing stereoselective polyolefin using the catalyst.

### Means for Solving Problem

As the results of intensive investigations, the present inventors have found that the above-mentioned problems can be solved by the present invention. The present invention can provide a catalyst which enables highly isoselective polymerization generating a polymer having significantly high molecular weight compared with the diphenoxy zirconium complex derived from trans-cyclooctane-1,2-dithiol described in Non-Patent literature 8 and which can prepare stereoselective polyolefin with a narrow dispersity (Mw/Mn) or a sharp molecular weight distribution. Furthermore, the catalyst of the present invention achieves highly isoselective polymerization to manufacture polyolefin having a high molecular weight and a narrow dispersity (Mw/Mn) or a sharp molecular weight distribution.

### BRIEF DESCRIPTION OF DRAWINGS

FIG. 1 shows a GPC chromatogram of poly(1-hexene) prepared in Example 6.

FIG. 2 shows a GPC chromatogram of poly(1-hexene) prepared in Example 8.

FIG. 3 shows a ¹³C-NMR spectrum indicating the stereoselectivity of poly(1-hexene) prepared in Example 6.

FIG. 4 shows a ¹³C-NMR spectrum indicating the stereoselectivity of poly(1-hexene) prepared in Example 8.

FIG. 5 shows a GPC chromatogram of poly(4-methyl-1-pentene) prepared in Example 11.

FIG. 6 shows a GPC chromatogram of poly(4-methyl-1-pentene) prepared in Example 12.

FIG. 7 shows a ¹³C-NMR spectrum indicating stereoselectivity of poly(4-methyl-1-pentene) prepared in Example 11.

FIG. 8 shows a ¹³C-NMR spectrum indicating stereoselectivity of poly(4-methyl-1-pentene) prepared in Example 12.

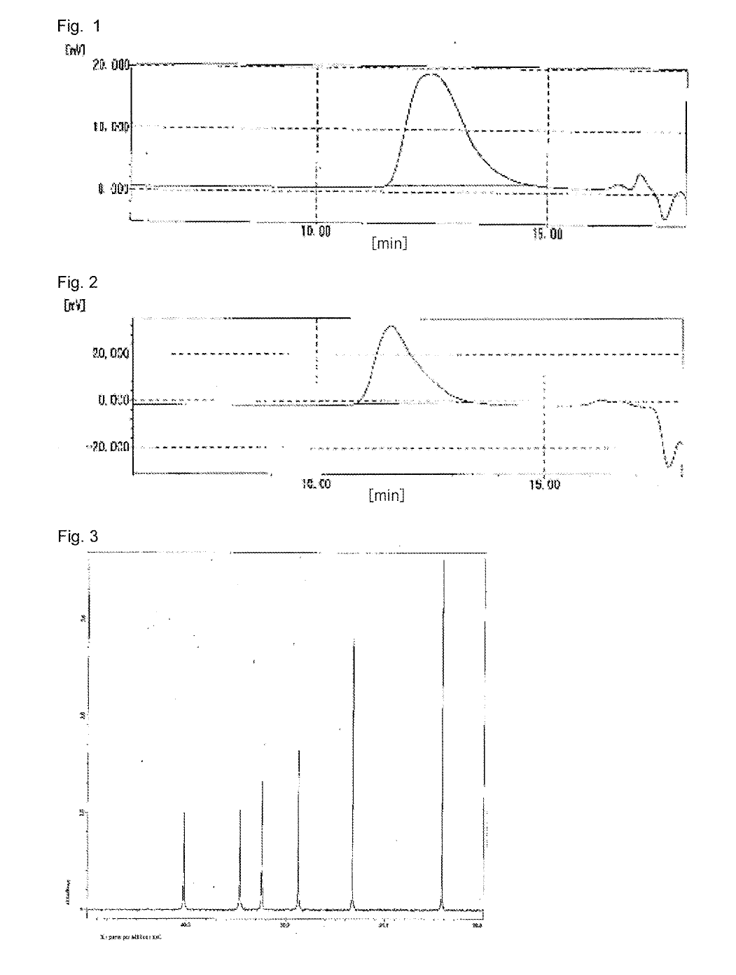

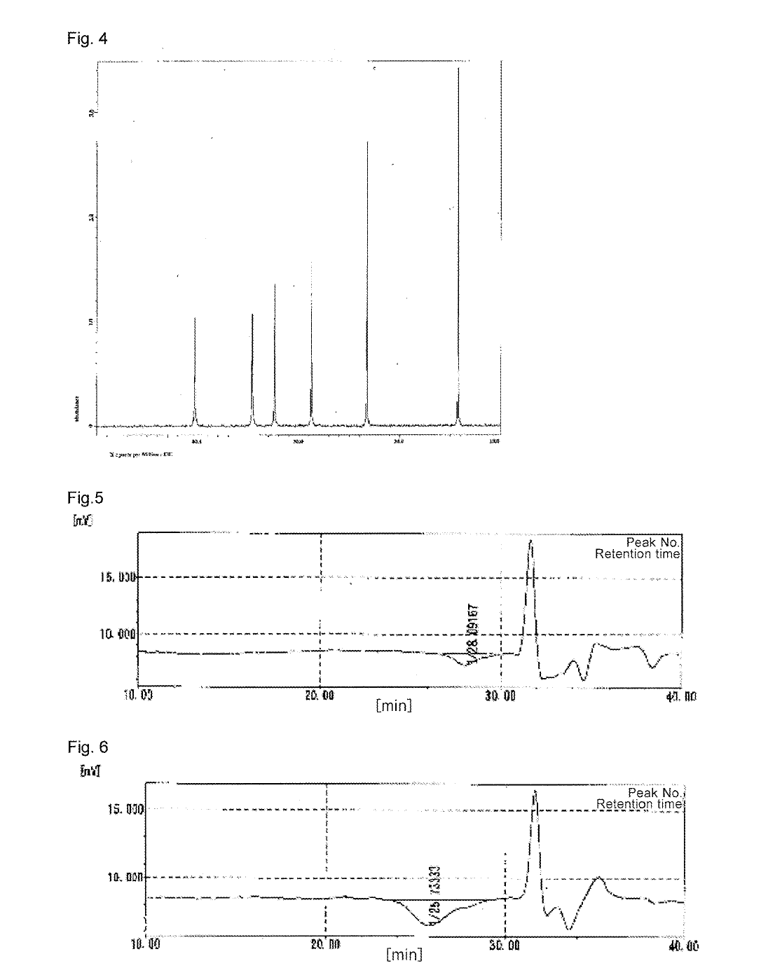

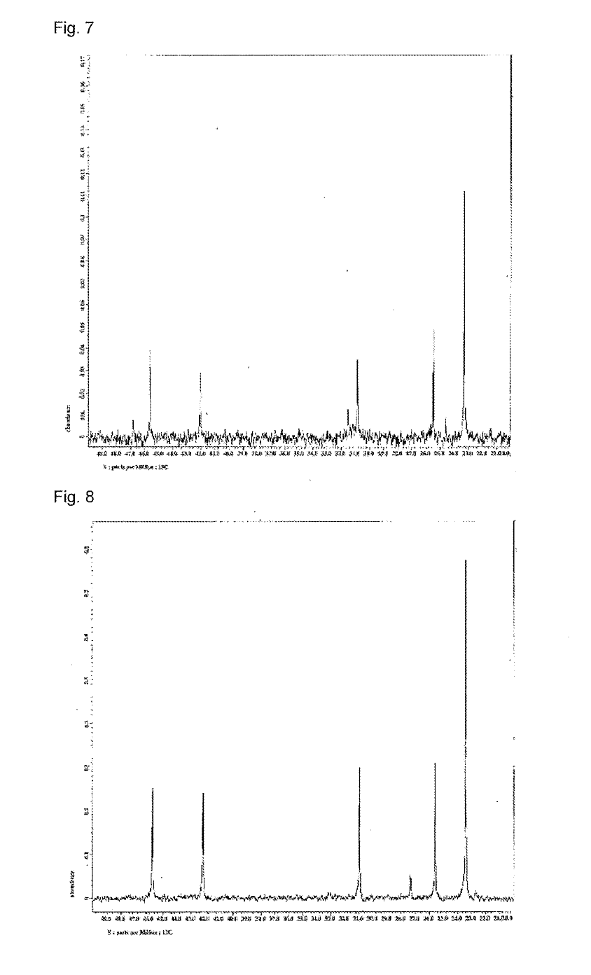

### DESCRIPTION OF EMBODIMENTS

The present invention relates to a stereoselective olefin polymerization catalyst comprising a complex represented by Formula (1).

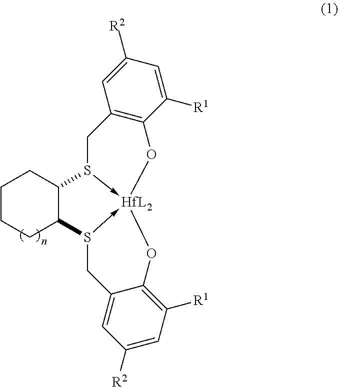

wherein n is 2 or 3; R¹ and R² are independently an optionally substituted alkyl group or a halogen atom; L is a ligand represented by CH₂R³, a halogen atom, OR⁴, or NR⁵R⁶; R³ is a hydrogen atom, an aromatic group, or a trialkylsilyl group; R⁴ is a lower alkyl group having 1 to 6 carbon atoms; and R⁵ and R⁶ are independently a hydrogen atom or a lower alkyl group having 1 to 6 carbon atoms.

The hafnium complex used in a catalyst of the present invention is represented by Formula (1), wherein n is 2 or 3, and preferably 3.

R¹ and R² are independently an optionally substituted alkyl group or a halogen atom (a fluorine atom, a chlorine atom, a bromine atom or an iodine atom), and the alkyl group is preferably an alkyl group having 1 to 30 carbon atoms, and more preferably an alkyl group having 1 to 12 carbon atoms. Examples of the alkyl group having 1 to 12 carbon atoms include a methyl group, an ethyl group, an isopropyl group, a t-butyl group, an n-pentyl group, an n-hexyl group, a cyclohexyl group, and an adamantyl group. Examples of the substituent attached to the alkyl group include a lower alkyl group having 1 to 6 carbon atoms, an optionally substituted phenyl group, and a halogen atom (a fluorine atom, a chlorine atom, a bromine atom or an iodine atom). Examples of the substituent that may be attached to the phenyl group include a lower alkyl group having 1 to 6 carbon atoms or a halogen atom (a fluorine atom, a chlorine atom, a bromine atom or an iodine atom).

The two R¹s may be the same or different, and the two R²s may be the same or different.

R¹ and R² are preferably an alkyl group, more preferably an alkyl group having 1 to 30 carbon atoms, still more preferably an alkyl group having 1 to 12 carbon atoms, and most preferably a t-butyl group, cyclohexyl group, or 1-adamantyl group.

L is CH₂R³ (a methyl group optionally having a substituent R³), a halogen atom (a fluorine atom, a chlorine atom, a bromine atom or an iodine atom), OR⁴ (an alkoxy group), or a ligand represented by NR⁵R⁶ (an amino group optionally having substituents R⁵ and R⁶). R³ is a hydrogen atom, an aromatic group, or a trialkylsilyl group. Examples of the aromatic group of R³ include a phenyl group, a 4-methoxyphenyl group, a 4-fluorophenyl group, a 4-chlorophenyl group, and a 4-bromophenyl group. The alkyl of the trialkylsilyl group can be a lower alkyl group having 1 to 6 carbon atoms and examples of the trialkylsilyl group include trimethylsilyl group, triethylsilyl group, and triisopropylsilyl group.

R⁴ is a lower alkyl group having 1 to 6 carbon atoms. Examples of the lower alkyl group include a methyl group, an ethyl group, an isopropyl group, a t-butyl group, an n-pentyl group, an n-hexyl group, and a cyclohexyl group. [0018]

R⁵ and R⁶ are independently a hydrogen atom or a lower alkyl group having 1 to 6 carbon atoms. Examples of the lower alkyl group include a methyl group, an ethyl group, an isopropyl group, a t-butyl group, an n-pentyl group, an n-hexyl group, and a cyclohexyl group.

L is preferably CH₂R³, a halogen atom or OR⁴, more preferably CH₂R³ or a halogen atom, still more preferably a methyl group, a benzyl group, a trimethylsilylmethyl group, a chlorine atom or a bromine atom, and most preferably a methyl group, a benzyl group or a chlorine atom.

Examples of the complex represented by Formula (1) include the following compounds:

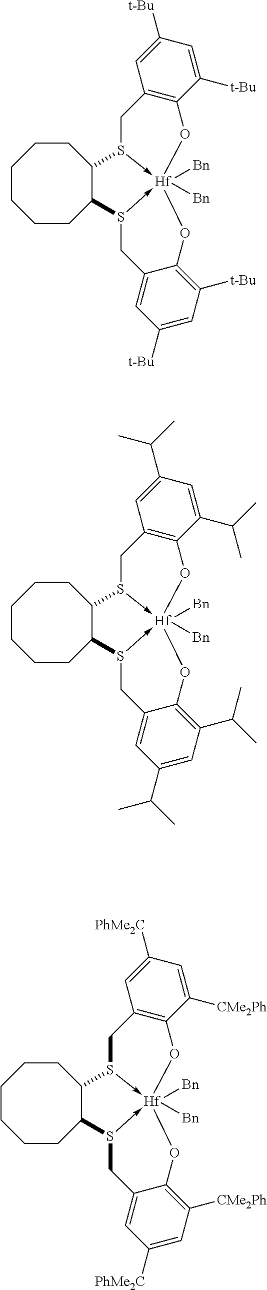

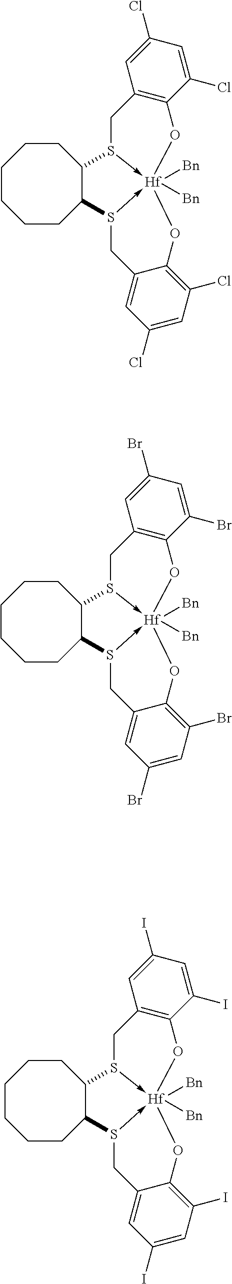

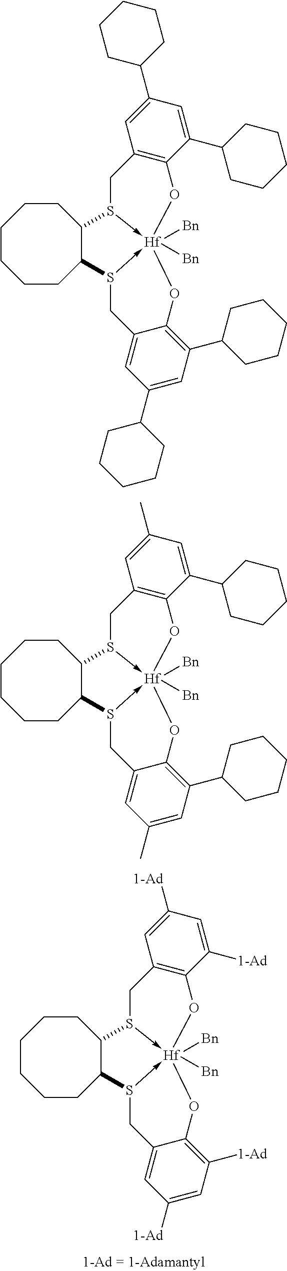

The complex also include compounds of which the benzyl group directly bonded to the hafnium atom is replaced with a fluorine atom, a chlorine atom, a bromine atom, an iodine atom, a dimethylamino group, diethylamino group, a methoxy group, an ethoxy group or t-butoxy group, or of which the 8-membered ring is replaced with a 7-membered ring.

The complexes represented by Formula (1) can be manufactured by the following steps using starting materials represented by Formulae (2) and (3).

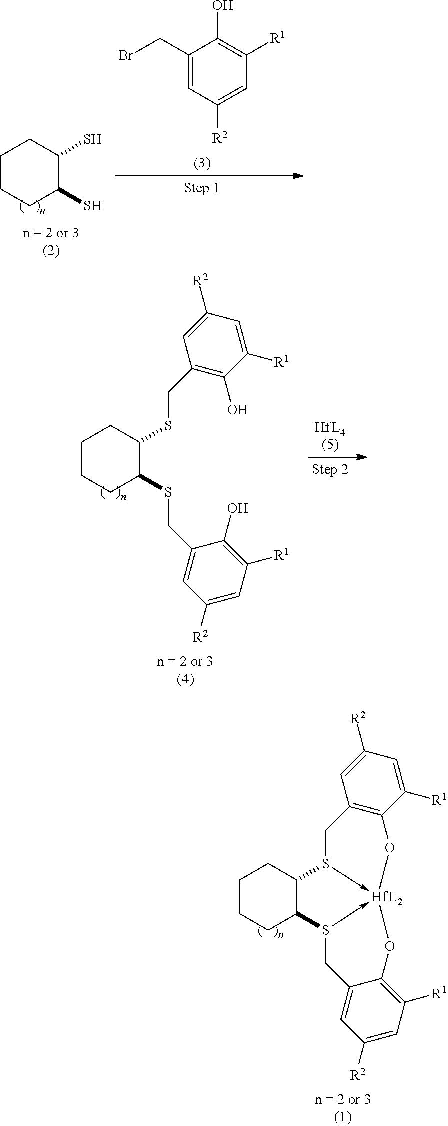

Each step will now be described in detail.

### [Step 1]

The tetradentate ligands represented by Compound (4) can be synthesized, for example, by the methods described in Non-Patent Literatures 7 and 8. In Compounds (3) and (4), n, R¹ and R² are as defined in Formula (1).

Trans-Cycloheptane-1,2-dithiol or trans-cyclooctane-1,2-dithiol corresponding to Compound (2) can be reacted with, for example, 2.0 to 4.0 equivalents, preferably 2.0 to 2.5 equivalents of 3,5-disubstituted 2-hydroxybenzyl bromide corresponding to Compound (3), thereby to yield the corresponding compound represented by Formula (4).

Examples of 3,5-disubstituted 2-hydroxybenzyl bromide include the following compounds. These compounds are known ones.

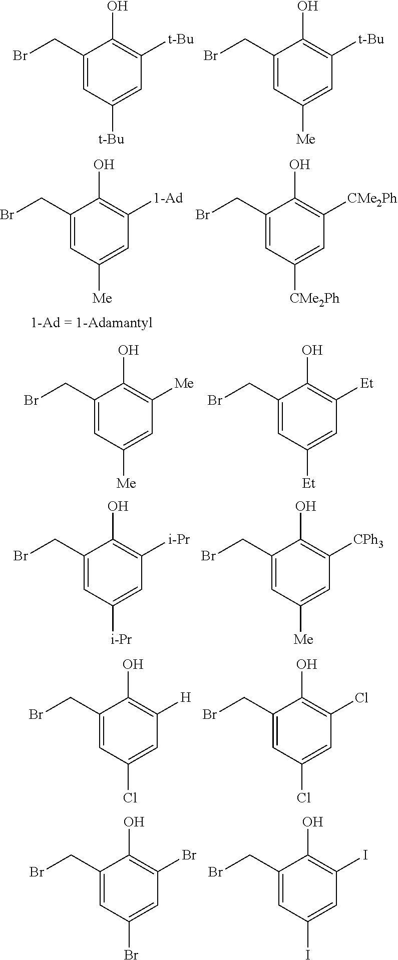

The reaction can be carried out in a stream of air, helium, argon or nitrogen, preferably in a stream of helium, argon or nitrogen, and more preferably in a stream of nitrogen or argon.

The reaction is generally carried out under atmospheric pressure since the effect of pressure can be neglected.

The temperature of reaction between the compound represented by Formula (2) with the compound represented by Formula (3) is, for example, in the range of −100° C. to 100° C., and preferably −80° C. to 80° C. However, there is no intention to limit the temperature to the ranges.

The time of reaction between the compound represented by Formula (2) and the compound represented by Formula (3) is, for example, in the range of 1 minute to 24 hours, preferably 5 minutes to 20 hours, and more preferably 30 minutes to 18 hours. However, there is no intention to limit the time to the ranges.

Examples of the compound represented by Formula (4) include the following compounds:

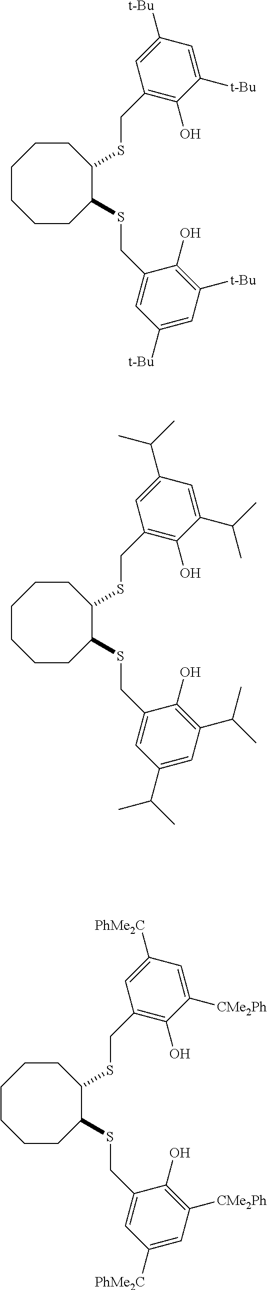

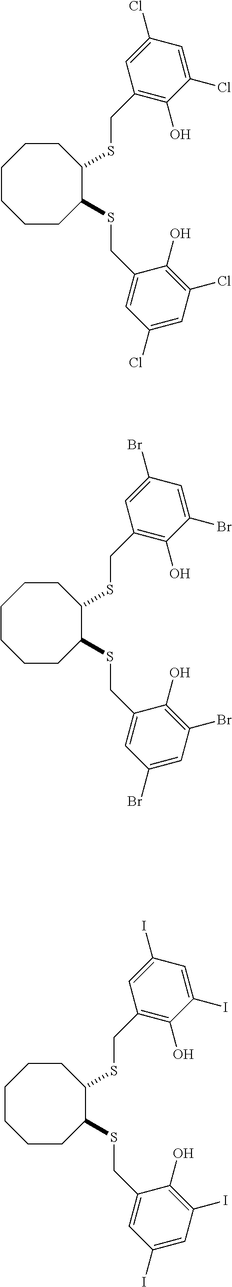

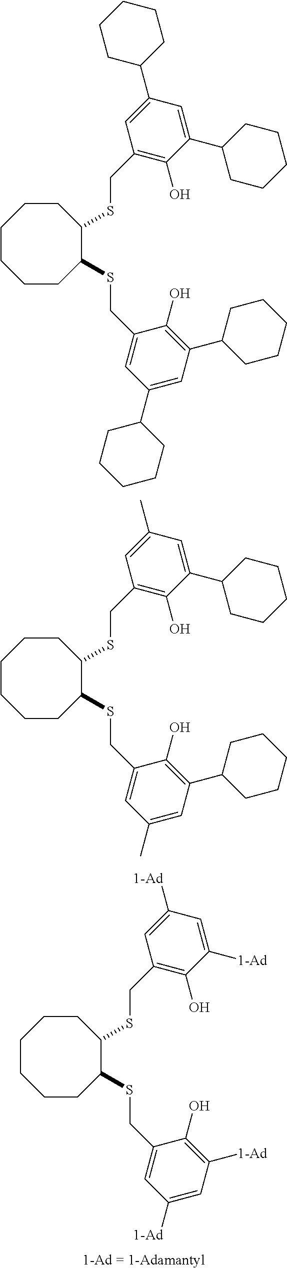

Compounds of which each 8-membered ring is replaced with a 7-membered ring are also included.

### [Step 2]

As described above, L in Compound (5) is a ligand represented by CH₂R³ (a methyl group optionally having a substituent R³), a halogen atom (a chlorine atom, a bromine atom, or an iodine atom), OR⁴ (an alkoxy group) or NR⁵R⁶ (an amino group optionally having substituents R⁵ and R⁶).

Examples of HfL₄ include Hf(CH₂Ph)₄, Hf(CH₂SiMe₃)₄, HfF₄, HfCl₄, HfBr₄, HfI₄, Hf(OMe)₄, Hf(OEt)₄, Hf(O-i-Pr)₄, Hf(O-n-Bu)₄, Hf(O-i-Bu)₄, Hf(O-t-Bu)₄, Hf(NMe₂)₄ and Hf(NEt₂)₄, and preferably Hf(CH₂Ph)₄, Hf(CH₂SiMe₃)₄, HfCl₄, HfBr₄, Hf(OMe)₄, Hf(OEt)₄, Hf(O-i-Pr)₄, Hf(O-i-Bu)₄, Hf(O-t-Bu)₄, Hf(NMe₂)₄, and Hf(NEt₂)₄.

In the case where the compound represented by Formula (5) is Hf(CH₂R³)₄, Hf(OR)₄ or Hf(NR⁵R⁶)₄, the compound can be reacted as it is with a compound represented by Formula (4) in a solvent.

It is appropriate to carry out the reaction preferably in a stream of helium, argon, or nitrogen, more preferably nitrogen or argon since hafnium complexes are unstable to air and humidity.

The reaction is generally carried out under atmospheric pressure since the effect of pressure can be neglected.

In the present invention, the temperature of reaction between the compound represented by Formula (4) with the compound represented by Formula (5) is, for example, in the range of −100° C. to 100° C., and preferably −80° C. to 50° C. However, there is no intention to limit the temperature to the ranges.

In the present invention, the reaction time of the compound represented by Formula (5) with a base is, for example, in the range of 1 minute to 24 hours, preferably 5 minutes to 12 hours, and more preferably 30 minutes to 3 hours. However, there is no intention to limit the time to the ranges.

In the case where the compound represented by Formula (5) is HfF₄, HfCl₄, HfBr₄ or HfI₄, the complex can be synthesized by the addition of any one of HfF₄, HfCl₄, HfBr₄, and HfI₄ to the reaction product of the compound represented by Formula (4) with a base such as an organolithium reagent, Grignard reagent or metal hydride, for example, n-butyl lithium, sec-butyl lithium, t-butyl lithium, lithium hydride, sodium hydride or potassium hydride.

In the present invention, the reaction temperature of the reaction product of the compound represented by Formula (4) and a base with the compound represented by Formula (5) is, for example, in the range of −100° C. to 150° C., and preferably −80° C. to 50° C. However, there is no intention to limit the temperature to the ranges.

In the present invention, the reaction time of the reaction product of the compound represented by Formula (4) and a base with the compound represented by Formula (5) is, for example, in the range of 1 minute to 24 hours, preferably 5 minutes to 12 hours, and more preferably 30 minutes to 3 hours. However, there is no intention to limit the temperature to the ranges.

The above-prepared complex represented by General formula (1) is reacted with an organolithium reagent or Grignard reagent to synthesize a complex in which L in General formula (1) is CH₂R³.

Any solvent commonly used in similar reactions can also be used without restriction in the present invention. Examples of such solvents include hydrocarbon solvents and ether solvents; preferably toluene, benzene, o-xylene, m-xylene, p-xylene, hexane, pentane, heptane, cyclohexane, diethyl ether, and tetrahydrofuran; and more preferably diethyl ether, toluene, tetrahydrofuran, hexane, pentane, heptane, and cyclohexane.

The complex represented by General formula (1) of the present invention is used as a polymerization catalytic component for manufacturing a polymer by homopolymerization of a polymerizable monomer or copolymerization of two or more polymerizable monomers, preferably by homopolymerization.

A polymerization catalyst that is prepared by putting the complex represented by General formula (1) of the present invention into contact with the co-catalytic component (A) is used as the polymerization catalyst. The co-catalytic component may be of any type which can activate the complex represented by General formula (1) of the present invention to induce the polymerization, and may contain at least one compound selected from the group consisting of an organoaluminum compound (A-1) and a boron compound (A-2).

### Organoaluminum Compound (A-1)

Known organoaluminum compounds can be used as the compound (A-1) of the present invention. Preferred examples of the compound include organoaluminum compounds (A-1-1) represented by General formula E¹ₐAIY¹₃₋ₐ, cyclic aluminoxanes (A-1-2) having a structure represented by General formula {—Al(E²)-O—}_{b}, and linear aluminoxanes (A-1-3) having a structure represented by General formula E³{—Al(E³)-O—}_{c}AlE³₂ (wherein E¹, E² and E³ are each a hydrocarbyl group having 1 to 8 carbon atoms, and all E¹s, E²s and E³s may be the same or different; Y¹ represents a hydrogen atom or a halogen atom, and all Y¹s may be the same or different; and a is an integer of 0<a≦3, b is an integer of 2 or more, and c is an integer of 1 or more); these may be used alone or as a mixture of two or three.

Examples of the organoaluminum compound (A-1-1) represented by General formula E¹ₐAlY¹₃₋ₐ include trialkylaluminums, such as trimethylaluminum, triethylaluminum, tripropylaluminum, triisobutylaluminum, and trihexylaluminum; dialkylaluminum chlorides, such as dimethylaluminum chloride, diethylaluminum chloride, dipropylaluminum chloride, diisobutylaluminum chloride, and dihexylaluminum chloride; alkylaluminum dichlorides, such as methylaluminum dichloride, ethylaluminum dichloride, propylaluminum dichloride, isobutylaluminum dichloride, and hexylaluminum dichloride; and dialkylaluminum hydrides, such as dimethylaluminum hydride, diethylaluminum hydride, dipropylaluminum hydride, diisobutylaluminum hydride, and dihexylaluminum hydride. Preferred are trialkylaluminums; and more preferred are triethylaluminum and triisobutylaluminum.

Examples of E² and E³ in cyclic aluminoxanes (A-1-2) having a structure represented by General formula {—Al(E²)-O—}_{b}, and linear aluminoxanes (A-1-3) having a structure represented by General formula E³{—Al(E³)-O—}_{c}—AlE³₂ include an alkyl group such as a methyl group, an ethyl group, an n-propyl group, an isopropyl group, an n-butyl group, an isobutyl group, an n-pentyl group, and a neopentyl group; and b is an integer of 2 or more, and c is an integer of 1 or more. Preferably, E² and E³ are each a methyl group or an isobutyl group, b is 2 to 40, and c is 1 to 40.

The aluminoxane is prepared by various processes without any particular restriction and may be prepared by any known process. Examples of the process of manufacturing the aluminoxane include putting a solution of a trialkylaluminum (e.g., trimethylaluminum) in an appropriate organic solvent (e.g., benzene, toluene, or aliphatic hydrocarbon) into contact with water; and putting a trialkylaluminum (e.g., trimethylaluminum) into contact with a metal salt containing water of crystallization (e.g., copper sulfate hydrate).

The resulting cyclic aluminoxane (A-1-2) having a structure represented by General formula {—Al(E²)-O—}_{b}, and linear aluminoxane (A-1-3) having a structure represented by General formula E³{—Al(E³)-O—}_{c}AlE³₂ may be, as necessary, dried through the removal of volatile components before use. Furthermore, the resulting dried compound after the removal of volatile components may be washed with an appropriate organic solvent (such as benzene, toluene, or aliphatic hydrocarbon) and dried again before use.

### Boron Compound (A-2)

The compound (A-2) used in the present invention may be any one of a boron compound (A-2-1) represented by General formula BR¹¹R¹²R¹³, a boron compound (A-2-2) represented by General formula W⁺(BR¹¹R¹²R¹³R¹⁴)⁻, and a boron compound (A-2-3) represented by General formula (V—H)⁺(BR¹¹R¹²R¹³R¹⁴)⁻.

In the boron compound (A-2-1) represented by General formula BR¹¹R¹²R¹³, B is a boron atom having a valence of three; and R¹¹ to R¹³ are each a halogen atom, a hydrocarbyl group having 1 to 20 carbon atoms, a halogenated hydrocarbyl group having 1 to 20 carbon atoms, a substituted silyl group having 1 to 20 carbon atoms, an alkoxy group having 1 to 20 carbon atoms, or a disubstituted amino group having 2 to 20 carbon atoms, where the substituents may be the same or different. Preferred R¹¹ to R¹³ are each a halogen atom, a hydrocarbyl group having 1 to 20 carbon atoms, or a halogenated hydrocarbyl group having 1 to 20 carbon atoms.

Examples of the compound (A-2-1) include triphenylborane, tris(pentafluorophenyl)borane, tris(2,3,5,6-tetrafluorophenyl)borane, tris(2,3,4,5-tetrafluorophenyl)borane, tris(3,4,5-trifluorophenyl)borane, tris(2,3,4-trifluorophenyl)borane, and bis(pentafluorophenyl)phenylborane, and the most preferred are triphenylborane and tris(pentafluorophenyl)borane.

In the boron compound (A-2-2) represented by General formula W⁺(BR¹¹R¹²R¹³R¹⁴)⁻, W⁺ is an inorganic or organic cation; B is a boron atom having a valence of three; and R¹¹ to R¹⁴ are the same as R¹¹ to R¹³ of the compound (A-2-1). More specifically, R¹¹ to R¹⁴ are each a halogen atom, a hydrocarbyl group having 1 to 20 carbon atoms, a halogenated hydrocarbyl group having 1 to 20 carbon atoms, a substituted silyl group having 1 to 20 carbon atoms, an alkoxy group having 1 to 20 carbon atoms, or a disubstituted amino group having 2 to 20 carbon atoms, where the substituents may be the same or different. Preferred R¹¹ to R¹⁴ are each a halogen atom, a hydrocarbyl group having 1 to 20 carbon atoms, and a halogenated hydrocarbyl group having 1 to 20 carbon atoms.

Examples of the inorganic cation W⁺ include ferrocenium cations, alkyl-substituted ferrocenium cations, and a silver cation, and examples of the organic cation W⁺ include triphenylcarbenium cations. Examples of (BR¹¹R¹²R¹³R¹⁴)⁻ include tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, tetrakis(2,3,4-trifluorophenyl)borate, bis(pentafluorophenyl)phenylborate, and tetrakis[3, 5-bis(trifluoromethyl)phenyl]borate.

Examples of the compound represented by General formula W⁺(BR¹¹R¹²R¹³R¹⁴)⁻ include ferrocenium tetrakis(pentafluorophenyl)borate, 1,1′-d imethylferrocenium tetrakis(pentafluorophenyl)borate, silver tetrakis(pentafluorophenyl)borate, triphenylcarbenium tetrakis(pentafluorophenyl)borate, and triphenylcarbenium tetrakis[3,5-bis(trifluoromethyl)phenyl]borate. The most preferred is triphenylcarbenium tetrakis(pentafluorophenyl)borate.

In the boron compound (A-2-3) represented by General formula (V—H)⁺(BR¹¹R¹²R¹³R¹⁴)⁻, V is a neutral Lewis base; (V—H)⁺ is a Broensted acid; B is a boron atom having a valence of three; and R¹¹ to R¹⁴ are the same as R¹¹ to R¹³ in the compound (A-2-3). More specifically, R¹¹ to R¹⁴ are each a halogen atom, a hydrocarbyl group having 1 to 20 carbon atoms, a halogenated hydrocarbyl group having 1 to 20 carbon atoms, a substituted silyl group having 1 to 20 carbon atoms, an alkoxy group having 1 to 20 carbon atoms, or a disubstituted amino group having 2 to 20 carbon atoms, where the substituents may be the same or different. Preferred R¹¹ to R¹⁴ are each a halogen atom, a hydrocarbyl group having 1 to 20 carbon atoms, and a halogenated hydrocarbyl group having 1 to 20 carbon atoms.

Examples of (V—H)⁺, which is a Broensted acid, include trialkyl-substituted ammoniums, N,N-dialkylaniliniums, dialkylammoniums, triarylphosphoniums, and examples of (BR¹¹R¹²R¹³R¹⁴)⁻ include the same as described above.

Examples of the compound represented by General formula (V—H)⁺(BR¹¹R¹²R¹³R¹⁴)⁻ include triethylammonium tetrakis(pentafluorophenyl)borate, tripropylammonium tetrakis(pentafluorophenyl)borate, tri(n-butyl)ammonium tetrakis(pentafluorophenyl)borate, tri(n-butyl)ammonium tetrakis[3,5-bis(trifluoromethyl)phenyl]borate, N,N-dimethyl anilinium tetrakis(pentafluorophenyl)borate, N,N-diethyl anilinium tetrakis(pentafluorophenyl)borate, N,N-2,4,6-pentamethylanilinium tetrakis(pentafluorophenyl)borate, N,N-d imethylanilinium tetrakis[3,5-bis(trifluoromethyl)phenyl]borate, diisopropylammonium tetrakis(pentafluorophenyl)borate, dicyclohexylammonium tetrakis(pentafluorophenyl)borate, triphenylphosphonium tetrakis(pentafluorophenyl)borate, tri(methylphenyl)phosphonium tetrakis(pentafluorophenyl)borate, tri(dimethylphenyl)phosphonium tetrakis(pentafluorophenyl)borate, and triphenylcarbenium tetrakis(pentafluorophenyl)borate. The most preferred is triphenylcarbenium tetrakis(pentafluorophenyl)borate, tri(n-butyl)ammonium tetrakis(pentafluorophenyl)borate or N,N-dimethylanilinium tetrakis(pentafluorophenyl)borate.

The contact between the complex represented by (1) and a co-catalyst component to manufacture a catalyst for olefin polymerization of the present invention may be made by any means which can put the complex represented by (1) into contact with the co-catalyst component to form the catalyst, and examples of such means include preliminarily mixing the component represented by (1) and the co-catalyst component, each optionally diluted with a solvent, to be in contact with each other, or adding the complex represented by (1) and the co-catalyst component separately to a polymerization tank to put them into contact with each other in the tank. In this method, mixed co-catalyst components of different types, parts of which may be either preliminarily mixed or separately added in the polymerization tank, can be used.

Each component is desirably used in such an amount that the molar ratio of the compound (A-1) to the complex represented by General formula (1) is generally in the range of 0.01 to 10000, preferably 1 to 5000, and the molar ratio of the compound (A-2) to the complex represented by General formula (1) is in the range of 0.01 to 100, and preferably 1.0 to 50.

In the case of manufacturing the catalyst in a polymerization reactor before polymerization reaction, although the concentration of each component supplied in a solution, suspension, or slurry in a solvent may be suitably selected according to the conditions such as the performance of a supply device, desirably the complex represented by General formula (1) is generally used in a concentration range of usually 0.0001 to 10000 mmol/L, preferably 0.001 to 1000 mmol/L, and more preferably 0.01 to 100 mmol, the compound (A-1) is generally used in a concentration range, on the basis of Al atoms, of usually 0.01 to 10000 mmol/L, preferably 0.05 to 5000 mmol/L, and more preferably 0.1 to 2000 mmol/L, and the compound (A-2) is generally used in a concentration range of usually 0.001 to 500 mmol/L, preferably 0.01 to 250 mmol/L, and more preferably 0.05 to 100 mmol/L.

The catalyst for olefin polymerization is prepared by putting the complex represented by General formula (1) into contact with the compound (A-1) and/or the compound (A-2). In the case where the catalyst for olefin polymerization prepared by putting the complex represented by General formula (1) into contact with the compound (A-1) is used, the compound (A-1) is preferably a cyclic aluminoxane (A-1-2) and/or a linear aluminoxane (A-1-3). In other preferred embodiments, the catalysts for olefin polymerization include catalysts for olefin polymerization prepared by putting the complex represented by General formula (1) into contact with the compound (A-1) and the compound (A-2), where a preferred compound (A-1) is the compound (A-1-1) for its ease of use, and the preferred compound (A-2) is the compound (A-2-1) or (A-2-2).

### Method for Manufacturing Stereoselective Polyolefin

The method for manufacturing stereoselective polyolefin of the present invention involves polymerization of olefin in the presence of the catalyst of the present invention. Olefins for polymerization may be used alone or as a mixture of two or more thereof, and preferably used alone. Polymerization of a single olefin yields a homopolymer, and polymerization of two or more olefins yields a copolymer. Any olefin compound can be used without restriction, and olefins which exhibit desired properties when stereoselectively polymerized are preferred. Olefins may be, for example, monoolefins or diolefins, and preferably monoolefins. Examples of the monoolefins include 1-alkenes (including branched alkenes), such as propylene, 1-butene, 1-pentene, 1-hexene, 1-heptene, 1-octene, 1-nonene, 1-decene, and 4-methyl-1-pentene; and cyclic alkenes, such as cyclopentene, cyclohexene, 5-methylnorbornene, 5-ethylnorbornene, 5-butylnorbornene, 5-phenylnorbornene, 5-benzylnorbornene, tetracyclododecene, tricyclodecene, tricycloundecene, pentacyclopentadecene, pentacyclohexadecene, 8-methyltetracyclododecene, 8-ethyltetracyclododecene, 5-acetylnorbornene, 5-acetyloxynorbornene, 5-methoxycarbonylnorbornene, 5-ethoxycarbonylnorbornene, 5-methyl-5-methoxycarbonylnorbornene, 5-cyanonorbornene, 8-methoxycarbonyltetracyclododecene, 8-methyl-8-tetracyclododecene, and 8-cyanotetracyclododecene. Examples of the diolefins include 1,5-hexadiene, 1,4-hexadiene, 1,6-heptadiene, 1,4-pentadiene, 1,7-octadiene, 1,8-nonadiene, 1,9-decadiene, 4-methyl-1,4-hexadiene, 5-methyl-1,4-hexadiene, 7-methyl-1,6-octadiene, 5-ethylidene-2-norbornene, dicyclopentadiene, 5-vinyl-2-norbornene, 5-methyl-2-norbornene, norbornadiene, 5-methylene-2-norbornene, 1,5-cyclooctadiene, 5,8-endomethylenehexahydronaphthalene, 1,3-hexadiene, 1,3-octadiene, 1,3-cyclooctadiene, 1,3-cyclohexadiene, and butadiene. Preferred examples of the monoolefins include propylene, 1-butene, 1-pentene, 1-hexene, 1-heptene, 1-octene, 1-nonene, 1-decene, and 4-methyl-1-pentene; and more preferred examples thereof include propylene, 1-butene, 1-pentene, 1-hexene, 1-octene, 1-decene, and 4-methyl-1-pentene. Still more preferred examples thereof include propylene, 1-butene, 1-pentene, 1-hexene, and 4-methyl-1-pentene. Preferred examples of the diolefins includes 1,5-hexadiene, 1,6-heptadiene, 5-ethylidene-2-norbornene, dicyclopentadiene, 5-vinyl-2-norbornene, 5-methyl-2-norbornene, norbornadiene, 5-methylene-2-norbornene, 1,5-cyclooctadiene, 1,3-cyclooctadiene, 1,3-cyclohexadiene, and butadiene. The more preferred examples thereof include 1,5-hexadiene, 1,6-heptadiene, 1,3-cyclohexadiene, and butadiene.

In the case of diolefins, the cyclopolymers, which are reported by R. M. Waymouth et al. (Journal of American Chemical Society, 1993, Volume 115, 91-98) and G. W. Coates (Macromolecular Rapid Communications, 2009, Volume 30, 1900-1906) can be prepared. More specifically, in the case of 1,5-hexadiene and 1,6-heptanediene, the following polymers can be prepared:

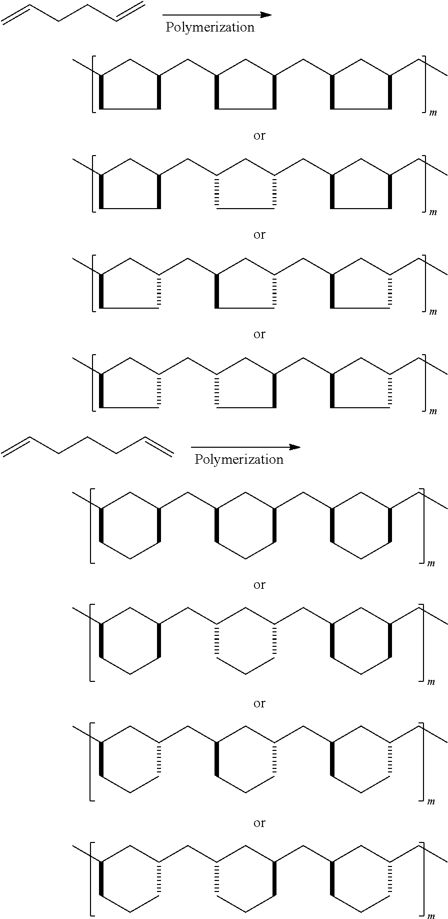

Non-limiting examples of polymerization include solvent polymerization and slurry polymerization, which use aliphatic hydrocarbon such as butane, pentane, hexane, heptane or octane, aromatic hydrocarbon such as benzene or toluene, or halogenated hydrocarbon such as methylene dichloride as solvents. The polymerization can be either continuous polymerization or batch polymerization. The polymerization temperature and time can be determined in consideration of a desired polymerizaion-average molecular weight and the activity and employed amount of the catalyst. The polymerization temperature is generally in the range of −50° C. to 200° C., and preferably in the range of −20° C. to 100° C. The polymerization pressure is preferably in the range of the normal pressure to 50 MPa. The polymerization time, which can be appropriately determined according to the type of the polymer to be prepared and the reactor, is in the range of, generally 1 minute to 20 hours, and preferably 5 minutes to 18 hours. However, there is no intention to limit the temperature to the ranges. Furthermore, in the present invention, chain transfer agents such as hydrogen can be added to adjust the molecular weight of the copolymer.

When a solvent is used in polymerization reaction, the concentration of each compound in the solvent is not specifically limited. The concentration of the hafnium complex in a solvent can be, for example, in the range of 1×10⁻⁸ mmol/L to 10 mol/L, and the concentration of the co-catalyst, for example, 1×10⁻⁸ mmol/L to 10 mol/L. The volume ratio of olefin to solvent (olefin:solvent) is in the range of 100:0 to 1:1000. These ranges are exemplary, and not restrictive. In the case where no solvent is used, the appropriate concentration can be determined with reference to the above range.

The unreacted monomer remaining with solvent in the resultant polymer can be removed as follows: For viscous polymers, the monomer can be removed with a vacuum pump. This process, however, cannot remove the catalyst. For solid polymers, the monomer can be removed by washing with a solvent such as methanol after the removal of the residual solvent. This method can remove a certain level of catalyst.

### EXAMPLES

The present invention will now be explained in more detail by way of examples and comparative examples, but the present invention should not be limited thereto.

Each item in Examples 1 to 12 and Comparative Examples 1 to 7 was measured by the following procedures.
(1) Weight-average molecular weight (Mw), number-average molecular weight (Mn), and molecular weight distribution (Mw/Mn)

These values were measured by gel permeation chromatography (GPC) under the following conditions. A calibration curve was determined using standard polystyrene samples. The molecular weight distribution was evaluated with the ratio (Mw/Mn) of the weight-average molecular weight (Mw) to the number-average molecular weight (Mn).
<Condition 1 for measurement of molecular weight, poly(1-hexene)>

Apparatus: HLC-8220 GPC apparatus manufactured by Tosoh Corp.

Columns: TSK gel SuperHZM-H (10)4.6*150 three columns

Measuring temperature: 40° C.

Solvent: tetrahydrofuran

Concentration of sample: 2 mg/2 mL
<Condition 2 for measurement of molecular weight, poly(4-methyl-1-pentene)>

Apparatus: HLC-8121 GPC/HT apparatus manufactured by Tosoh Corp.

Columns: TSK gel GMHHR-H(20) HT 7.8*300 three columns

Measuring temperature: 145° C.

Solvent: 1,2-dichlorobenzene

Concentration of sample: 5 mg/5 mL
(2) Isoselectivity (mmmm, unit: %)

Carbon nuclear magnetic resonance spectra (¹³C-NMR) were obtained by carbon nuclear magnetic resonance spectroscopy under the following conditions to determine the values from the following calculation procedures.
<Condition 1 for measurement of tacticity, poly(1-hexene)>

Apparatus: ECS400 manufactured by JEOL Ltd.

Solvent used for measurement: chloroform-d₁

Measuring temperature: 25° C.

Measuring mode: proton decoupling mode

Pulse width: 30 degrees

Pulse repetition time: 2 seconds

Reference: residual chloroform in deuterochloroform

Window function: negative exponential function
<Condition 2 for measurement of tacticity, poly(4-methyl-1-pentene)>

Apparatus: ECS400 manufactured by JEOL Ltd.

Solvent used for measurement: tetrachloroethane-d₂

Measuring temperature: 130° C.

Measuring mode: proton decoupling mode

Pulse width: 30 degrees

Pulse repetition time: 2 seconds

Reference: residual tetrachloroethane in deuterotetrachloroethane

Window function: negative exponential function
<Calculation procedure 1, poly(1-hexene)>

The area of a peak at around 34.60 to 34.65 ppm was determined. The peak area was defined as the signal peak area in the range from a chemical shift at a valley to the adjacent peak in a higher magnetic field to a chemical shift at a valley to the adjacent peak in a lower magnetic field.
<Calculation procedure 2, poly(4-methyl-1-pentene)>

The peak of a peak at around 45.61 to 45.66 ppm was determined. The peak area was defined as the signal peak area in the range from a chemical shift at a valley to the adjacent peak in a higher magnetic field to a chemical shift at a valley to the adjacent peak in a lower magnetic field.

### Reference Example 1

### Synthesis of trans-1,2-bis(2-hydroxy-3,5-di-tert-butylbenzylsulfanyl)cyclooctane

In an argon atmosphere, trans-cyclooctane-1,2-dithiol (2.18 g, 12.4 mmol) and 3,5-di-t-butyl-2-hydroxybenzyl bromide (7.52 g, 25.1 mmol) were dissolved in tetrahydrofuran (80 mL), and the solution was cooled to 0° C. Triethylamine (3.5 mL, 24.9 mmol) was then added thereto, and the solution was stirred at 0° C. for 1 hour and further at room temperature overnight. The formed precipitate was removed by filtration and the filtrate was concentrated under reduced pressure. Ether and a saturated aqueous ammonium chloride solution were added to the residue. The ether layer was then washed with water and was dried through anhydrous magnesium sulfate, and the solvent was evaporated under reduced pressure. The residue was purified by silica gel column chromatography (developing solvent: hexane/dichloromethane=1/1) to give a title compound as a colorless crystal (6.74 g, yield 89%).

Melting point: 122 to 123° C. (recrystallized from hexane)

¹H-NMR (400 MHz, δ, ppm, CDCl₃) 1.12-1.94 (m, 48H), 2.63-2.65 (m, 2H), 3.81 (d, J=13 Hz, 2H), 3.90 (d, J=13 Hz, 2H), 6.92 (d, J=2 Hz, 2H), 6.95 (s, 2H), 7.26 (d, J=2 Hz, 2H).

¹³C-NMR (100.7 MHz, δ, CDCl₃)

25.7, 25.8, 29.8, 31.2, 31.6, 34.2, 35.0, 35.4, 49.6, 121.6, 123.7, 125.4, 137.4, 142.0, 152.2.

Elemental analysis; calculated value (C₃₈H₆₀O₂S₂), C, 74.45%; H, 9.87%

Observed value: C, 74.39%; H, 10.09%

Reference; A. Ishii, A. Ono, N. Nakata, J. SuIf Chem 2009, 30, 236-244.

### Reference Example 2

### Synthesis of trans-1,2-bis(2-hydroxy-3,5-di-tert-butylbenzylsulfanyl)cyclohexane

In an argon atmosphere, trans-cyclohexane-1,2-dithiol (1.08 g, 7.3 mmol) and 3,5-di-t-butyl-2-hydroxybenzyl bromide (4.58 g, 15.3 mmol) were dissolved in tetrahydrofuran (90 mL), and the solution was cooled to 0° C. Triethylamine (2.13 mL, 15.3 mmol) was then added thereto and the solution was stirred at 0° C. for 15 hours. The formed precipitate was removed by filtration and the filtrate was concentrated under reduced pressure. Ether and dilute hydrochloric acid were added to the residue. The ether layer was then washed with water and was dried through anhydrous magnesium sulfate, and the solvent was evaporated under reduced pressure. The residue was purified by silica gel column chromatography (developing solvent: hexane/dichloromethane=1/1) to give a title compound as a colorless crystal (3.86 g, yield 90%).

Melting point: 104 to 106° C., decomposed (recrystallized from ethanol)

¹H-NMR (400 MHz, δ, ppm, CDCl₃) 1.19-1.43 (m, 44H), 2.09-2.15 (m, 2H), 2.58-2.61 (m, 2H), 3.79 (s, 4H), 6.75 (s, 2H), 6.93 (d, J=2 Hz, 2H), 7.25 (d, J=2 Hz, 2H).

¹³C-NMR (100.7 MHz, δ, CDCl₃)

24.7, 29.7, 31.6, 32.6, 33.9, 34.2, 35.0, 48.1, 121.6, 123.7, 125.2, 137.3, 142.2, 152.0.

Elemental analysis: calculated value (C₃₆H₅₆O₂S₂): C, 73.92%; H, 9.34%.

Observed value: C, 74.17%; H, 9.31%

### Reference Example 3

### [Cyclooctanediyl-trans-1,2-bis(2-oxoyl-3,5-di-tert-butylbenzylsulfanyl)]dibenzylzirconium

The following experiment was carried out in an argon atmosphere in a glove box. In a 50 mL Schlenk flask, trans-1,2-bis(2-hydroxy-3,5-di-tert-butylbenzylsulfanyl)cyclooctane (207 mg, 0.336 mmol) was dissolved in toluene (10 mL), and then tetrabenzylzirconium (153 mg, 0.336 mmol) in toluene (10 mL) was added dropwise to the solution at room temperature. The mixture was stirred for one hour. Toluene was evaporated under reduced pressure, and the residue was washed with hexane (2 mL) and was dried to give a title compound as a colorless crystal (216 mg, yield 76%).

Melting point: 181-183° C. (decomposed)

1.16-1.80 (m, 48H), 2.16 (d, J=10 Hz, 2H), 2.42 (m, 2H), 2.78 (d, J=10 Hz, 2H), 3.16 (d, J=14 Hz, 2H), 3.50 (d, J=14 Hz, 2H), 6.61 (d, J=2 Hz, 2H), 6.90 (t, J=8 Hz, 2H), 7.09 (t, J=8 Hz, 4H), 7.25 (t, J=8 Hz, 4H), 7.52 (d, J=2 Hz, 2H).

¹³C-NMR (100.4 MHz, δ, ppm, C₆D₆)

25.2, 26.1, 28.6, 30.6, 31.7, 34.2, 34.8, 35.7, 48.7, 64.0, 122.0, 123.1, 124.3, 126.2, 128.5, 128.7, 129.6, 140.9, 145.8, 158.0.

Elemental analysis: calculated value (C₅₂H₇₂O₂S₂Zr), C, 70.61%; H, 8.21%.

Observed value: C, 70.54%; H, 8.31%.

### Reference Example 4

### [Cyclohexanediyl-trans-1,2-bis(2-oxoyl-3,5-di-tert-butylbenzylsulfanyl)]dibenzylhafnium

The following experiment was carried out in an argon atmosphere in a glove box. In a 100 mL Schlenk flask, trans-1,2-bis(2-hydroxy-3,5-di-tert-butylbenzylsulfanyl)cyclohexane (200.0 mg, 0.342 mmol) was dissolved in toluene (10 mL), and then tetrabenzylhafnium (185.7 mg, 0.342 mmol) in toluene (10 mL) was added dropwise to the solution at room temperature. The mixture was stirred for one hour. Toluene was evaporated under reduced pressure, and the residue was washed with hexane (2 mL) three times and was dried to give a title compound (diastereomeric mixture) as a colorless crystal (201.3 mg, yield 62%). The diastereomer ratio was 64/36.

Major: ¹H-NMR (400 MHz, δ, ppm, CD₃C₆D₅) 1.06-1.92 (m, 44H), 2.55(d, J=12.0 Hz, 2H), 2.84(d, J=12.0 Hz, 2H), 3.21(d, J=14.0 Hz, 2H), 3.37(d, J=14.0 Hz, 2H), 6.62 (d, J=2.4 Hz, 2H), 6.74-6.81(m, 2H), 7.04-7.12(m, 6H), 7.25(d, J=7.6 Hz, 4H), 7.54 (d, J=2.4 Hz, 2H).

Minor: ¹H-NMR (400 MHz, δ, ppm, CD₃C₆D₅) 1.06-1.92 (m, 44H), 2.38(d, J=11.6 Hz, 2H), 2.85(d, J=14.0 Hz, 2H), 2.94(d, J=11.6 Hz, 2H), 3.18(d, J=14.0 Hz, 2H), 6.59 (d, J=2.4 Hz, 2H), 6.74-6.81(m, 2H), 7.04-7.12(m, 6H), 7.31(d, J=7.6 Hz, 4H), 7.47 (d, J=2.4 Hz, 2H).

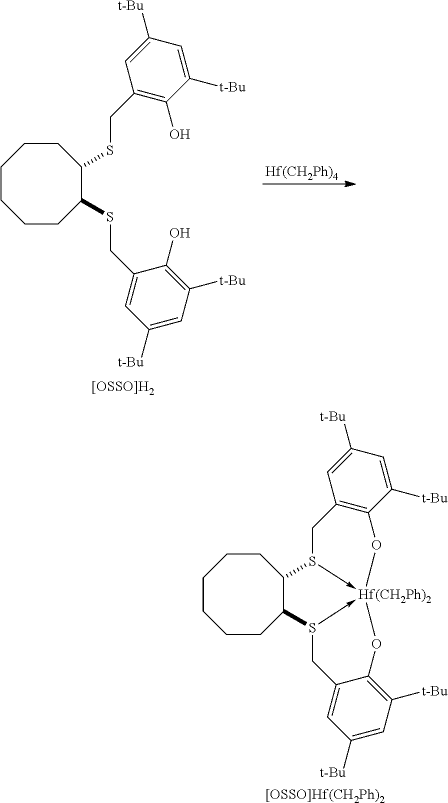

### [Cyclooctanediyl-trans-1,2-bis(2-oxoyl-3,5-di-tert-butylbenzylsulfanyl)]dibenzylhafnium

The following experiment was carried out in an argon atmosphere in a glove box. In a 50 mL Schlenk flask, trans-1,2-bis(2-hydroxy-3,5-di-tert-butylbenzylsulfanyl)cyclooctane (192 mg, 0.313 mmol) was dissolved in toluene (10 mL), and then tetrabenzylzirconium (170 mg, 0.313 mmol) in toluene (10 mL) was added dropwise to the solution at room temperature. The mixture was stirred for one hour. Toluene was evaporated under reduced pressure, and the residue was washed with hexane (2 mL) and was dried to give a title compound as a colorless crystal (209 mg, yield 69%).

Melting point: 203° C. (decomposed)

¹H-NMR (400 MHz, δ, ppm, C₆D₆) 1.18-1.94 (m, 48H), 2.35 (m, 2H), 2.61 (d, J=12 Hz, 2H), 2.88 (d, J=12 Hz, 2H), 3.13 (d, J=14 Hz, 2H), 3.41 (d, J=14 Hz, 2H), 6.62 (d, J=2 Hz, 2H), 6.78 (t, J=8 Hz, 2H), 7.10 (t, J=8 Hz, 4H), 7.29 (t, J=8 Hz, 4H), 7.57 (d, J=2 Hz, 2H)

¹³C-NMR (100.4 MHz, δ, ppm, C₆D₆)

25.1, 26.2, 28.8, 30.5, 31.8, 32.1, 34.2, 35.6, 49.1, 77.2, 121.4, 121.8, 124.6, 125.6, 126.0, 129.3, 138.5, 141.1, 148.4, 157.9.

Elemental analysis: calculated value (C₅₂H₇₂O₂S₂Hf), C, 64.27%; H, 7.47%.

Observed value: C, 63.87%; H, 7.59%.

### Reference Example 6

### [Cyclooctanediyl-trans-1,2-bis(2-oxoyl-3,5-di-tert-butylbenzylsulfanyl)]dichlorohafnium

The following experiment was carried out in an argon atmosphere. In a 100 mL Schlenk flask, trans-1,2-bis(2-hydroxy-3,5-di-tert-butylbenzylsulfanyl)cyclooctane (1.00 g, 1.63 mmol) was dissolved in diethyl ether (20 mL), and then n-butyl lithium (2 mL, 1.65 mol/L, 3.30 mmol) was added to the solution. The mixture was stirred at 0° C. for 30 minutes. The solution was then added dropwise to tetrachlorohafnium (530 mg, 1.65 mmol) in diethyl ether (50 mL) at room temperature and the mixture was stirred overnight. The formed precipitate was removed by filtration and the filtrate was concentrated under reduced pressure. The residue was washed with pentane (5 mL) and was dried to give a title compound as a colorless crystal (558 mg, yield 40%).

¹H-NMR (400 MHz, δ, ppm, C₆D₆) 0.54-1.86 (m, 48H), 2.56 (br s, 2H), 3.20 (d, J=14 Hz, 2H), 4.35 (d, J=14 Hz, 2H), 6.56 (br s, 2H), 7.56 (br s, 2H).

¹³C-NMR (100.4 MHz, δ, ppm, C₆D₆)

24.9, 26.1, 28.8, 30.4, 31.8, 34.3, 35.5, 36.0, 49.3, 120.3, 125.1, 125.7, 139.4, 142.1, 157.3.

Table 1 summarizes the experimantal conditions and the observed molecular weights of poly(1-hexene) products. The following experiments were carried out in an argon atmosphere in a glove box, and the molecular weight was determined in accordance with <Condition 1 for measurement of molecular weight> and the tacticity was determined in accordance with <Condition 1 for measurement of tacticity> and <Calculation procedure 1>.

### Example 1

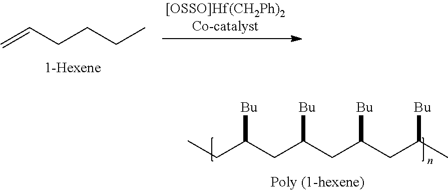

In a 50 mL Schlenk flask, [cyclooctanediyl-trans-1,2-bis(2-oxoyl-3,5-di-tert-butylbenzylsulfanyl)]dibenzylhafnium (19.4 mg, 0.020 mmol) was dissolved in benzene (1 mL) and hexane (5 mL), and then tris(pentafluorophenyl)borane [B(C₆F₅)₃] (10.2 mg, 0.020 mmol) was added to the solution at 25° C. The mixture was stirred for 5 minutes. After 1-hexene (3 g, 35.6 mmol) was added to the solution at 25° C., the mixture was stirred for 10 minutes. Methanol was added to the reaction solution to quench the reaction and the volatile components were evaporated at 70° C. with a vacuum pump to give poly(1-hexene) (0.62 g, yield 21%). With the stereoselectivity, the resulting poly(1-hexene) had an isoselectivity (mmmm) of 99.3% from ¹³C-NMR data, with Mw=120000 and Mw/Mn=1.3.

### Example 2

In a 50 mL Schlenk flask, [cyclooctanediyl-trans-1,2-bis(2-oxoyl-3,5-di-tert-butylbenzylsulfanyl)]dibenzylhafnium (19.4 mg, 0.020 mmol) was dissolved in benzene (1 mL) and hexane (5 mL), and then tris(pentafluorophenyl)borane [B(C₆F₅)₃] (10.2 mg, 0.020 mmol) was added to the solution at 25° C. The mixture was stirred for 5 minutes. After 1-hexene (3 g, 35.6 mmol) was added to the solution at 25° C., the mixture was stirred for 20 minutes. Methanol was added to the reaction solution to quench the reaction, and the volatile components were evaporated at 70° C. with a vacuum pump to give poly(1-hexene) (1.20 g, yield 40%). With the stereoselectivity, the resulting poly(1-hexene) had an isoselectivity (mmmm) of 98.9% from ¹³C-NMR data, with Mw=185000 and Mw/Mn=1.5.

### Example 3

In a 50 mL Schlenk flask, [cyclooctanediyl-trans-1,2-bis(2-oxoyl-3,5-di-tert-butylbenzylsulfanyl)]dibenzylhafnium (19.4 mg, 0.020 mmol) was dissolved in benzene (1 mL) and hexane (5 mL), and then tris(pentafluorophenyl)borane [B(C₆F₅)₃] (10.2 mg, 0.020 mmol) was added to the solution at 25° C. The mixture was stirred for 5 minutes. After 1-hexene (3 g, 35.6 mmol) was added to the solution at 25° C., the mixture was stirred for 30 minutes. Methanol was added to the reaction solution to quench the reaction and the volatile components were evaporated at 70° C. with a vacuum pump to give poly(1-hexene) (2.16 g, yield 72%). With the stereoselectivity, the resulting poly(1-hexene) had an isoselectivity (mmmm) of 97.0% from ¹³C-NMR data, with Mw=227000 and Mw/Mn=1.7.

### Example 4

In a 50 mL Schlenk flask, [cyclooctanediyl-trans-1,2-bis(2-oxoyl-3,5-di-tert-butylbenzylsulfanyl)]dibenzylhafnium (19.4 mg, 0.020 mmol) was dissolved in benzene (1 mL), and then tris(pentafluorophenyl)borane [B(C₆F₅)₃] (10.2 mg, 0.020 mmol) was added to the solution at 25° C. The mixture was stirred for 5 minutes. After 1-hexene (3 g, 35.6 mmol) was added to the solution at 25° C., the mixture was stirred for 4 minutes. Methanol was added to the reaction solution to quench the reaction and the volatile components were evaporated at 70° C. with a vacuum pump to give poly(1-hexene) (0.29 g, yield 10%). With the stereoselectivity, the resulting poly(1-hexene) had an isoselectivity (mmmm) of 99.2% from ¹³C-NMR data, with Mw=100000 and Mw/Mn=1.3.

### Example 5

In a 50 mL Schlenk flask, [cyclooctanediyl-trans-1,2-bis(2-oxoyl-3,5-di-tert-butylbenzylsulfanyl)]dibenzylhafnium (19.4 mg, 0.020 mmol) was dissolved in benzene (1 mL), and then tris(pentafluorophenyl)borane [B(C₆F₅)₃] (10.2 mg, 0.020 mmol) was added to the solution at 25° C. The mixture was stirred for 5 minutes. After 1-hexene (3 g, 35.6 mmol) was added to the solution at 25° C., the mixture was stirred for 7 minutes. Methanol was added to the reaction solution to quench the reaction and the volatile components were evaporated at 70° C. with a vacuum pump to give poly(1-hexene) (0.95 g, yield 32%). With the stereoselectivity, the resulting poly(1-hexene) had an isoselectivity (mmmm) of 99.3% from ¹³C-NMR data, with Mw=170000 and Mw/Mn=1.5.

### Example 6

In a 50 mL Schlenk flask, [cyclooctanediyl-trans-1,2-bis(2-oxoyl-3,5-di-tert-butylbenzylsulfanyl)]dibenzylhafnium (19.4 mg, 0.020 mmol) was dissolved in benzene (1 mL), and then tris(pentafluorophenyl)borane [B(C₆F₅)₃] (10.2 mg, 0.020 mmol) was added to the solution at 25° C. The mixture was stirred for 5 minutes. After 1-hexene (3 g, 35.6 mmol) was added to the solution at 25° C., the mixture was stirred for 10 minutes. Methanol was added to the reaction solution to quench the reaction and the volatile components were evaporated at 70° C. with a vacuum pump to give poly(1-hexene) (2.02 g, yield 67%). With the stereoselectivity, the resulting poly(1-hexene) had an isoselectivity (mmmm) of 98.9% from ¹³C-NMR data, with Mw=191000 and Mw/Mn=1.8.

### Example 7

In a 50 mL Schlenk flask, [cyclooctanediyl-trans-1,2-bis(2-oxoyl-3,5-di-tert-butylbenzylsulfanyl)]dibenzylhafnium (19.4 mg, 0.020 mmol) was dissolved in toluene (5 mL), and then triphenylcarbenium tetrakis(pentafluorophenyl)borate [Ph₃CB(C₆F₅)₄] (18.4 mg, 0.020 mmol) was added at 0° C. to the solution. The mixture was stirred for 5 minutes. After 1-hexene (3 g, 35.6 mmol) was added to the solution at 25° C., the mixture was stirred for 15 minutes. Methanol was added to the reaction solution to quench the reaction and the volatile components were evaporated at 70° C. with a vacuum pump to give poly(1-hexene) (0.76 g, yield 25%). With the stereoselectivity, the resulting poly(1-hexene) had an isoselectivity (mmmm) of 98.2% from ¹³C-NMR data, with Mw=256000 and Mw/Mn=1.5.

### Example 8

In a 50 mL Schlenk flask, [cyclooctanediyl-trans-1,2-bis(2-oxoyl-3,5-di-tert-butylbenzylsulfanyl)]dibenzylhafnium (19.4 mg, 0.020 mmol) was dissolved in toluene (5 mL), and then triphenylcarbenium tetrakis(pentafluorophenyl)borate [Ph₃CB(C₆F₅)₄] (18.4 mg, 0.020 mmol) was added at 0° C. to the solution. The mixture was stirred for 5 minutes. After 1-hexene (3 g, 35.6 mmol) was added to the solution at 25° C., the mixture was stirred for 30 minutes. Methanol was added to the reaction solution to quench the reaction and the volatile components were evaporated at 70° C. with a vacuum pump to give poly(1-hexene) (2.20 g, yield 73%). With the stereoselectivity, the resulting poly(1-hexene) had an isoselectivity (mmmm) of 99.7% from ¹³C-NMR data, with Mw=421000 and Mw/Mn=1.6.

### Comparative Example 1

In a 50 mL Schlenk flask, 1-hexene (3 g, 35.6 mmol) without a solvent was added to [cyclooctanediyl-trans-1,2-bis(2-oxoyl-3,5-di-tert-butylbenzylsulfanyl)]dibenzylzirconium (17.7 mg, 0.020 mmol) and tris(pentafluorophenyl)borane [B(C₆F₅)₃] (10.2 mg, 0.020 mmol) at 25° C. The mixture was stirred for 5 minutes. Methanol was added to the reaction solution to quench the reaction and the volatile components were evaporated at 70° C. with a vacuum pump to give poly(1-hexene) (2.68 g, yield 89%). With the stereoselectivity, the resulting poly(1-hexene) had an isoselectivity (mmmm) of 95.3% from ¹³C-NMR data, with Mw=43000 and Mw/Mn=1.9.

### Comparative Example 2

In a 50 mL Schlenk flask, [cyclooctanediyl-trans-1,2-bis(2-oxoyl-3,5-di-tert-butylbenzylsulfanyl)]dibenzylzirconium (17.7 mg, 0.020 mmol) was dissolved in benzene (1 mL) and hexane (5 mL), and then tris(pentafluorophenyl)borane [B(C₆F₅)₃] (10.2 mg, 0.020 mmol) was added at 25° C. to the solution. The mixture was stirred for 5 minutes. After 1-hexene (3 g, 35.6 mmol) was added to the solution at 25° C., the mixture was stirred for 10 minutes. Methanol was added to the reaction solution to quench the reaction and the volatile components were evaporated at 70° C. with a vacuum pump to give poly(1-hexene) (2.86 g, yield 95%). With the stereoselectivity, the resulting poly(1-hexene) had an isoselectivity (mmmm) of 97.6% from ¹³C-NMR data, with Mw=43000 and Mw/Mn=1.9.

### Comparative Example 3

In a 50 mL Schlenk flask, [cyclooctanediyl-trans-1,2-bis(2-oxoyl-3,5-di-tert-butylbenzylsulfanyl)]dibenzylzirconium (17.7 mg, 0.020 mmol) was dissolved in benzene (1 mL) and hexane (5 mL), and then triphenylcarbenium tetrakis(pentafluorophenyl)borate [Ph₃CB(C₆F₅)₄] (18.4 mg, 0.020 mmol) was added at 25° C. to the solution. The mixture was stirred for 5 minutes. After 1-hexene (3 g, 35.6 mmol) was added to the solution at 25° C., the mixture was stirred for 10 minutes. Methanol was added to the reaction solution to quench the reaction and the volatile components were evaporated at 70° C. with a vacuum pump to give poly(1-hexene) (2.90 g, yield 97%). With the stereoselectivity, the resulting poly(1-hexene) had an isoselectivity (mmmm) of 97.4% from ¹³C-NMR data, with Mw=41000 and Mw/Mn=2.1.

### Comparative Example 4

In a 50 mL Schlenk flask, [cyclooctanediyl-trans-1,2-bis(2-oxoyl-3,5-di-tert-butylbenzylsulfanyl)]dibenzylzirconium (17.7 mg, 0.020 mmol) was dissolved in benzene (2 mL) and hexane (10 mL), and then triphenylcarbenium tetrakis(pentafluorophenyl)borate [Ph₃CB(C₆F₅)₄] (18.4 mg, 0.020 mmol) was added at 25° C. to the solution. The mixture was stirred for 5 minutes. After 1-hexene (3 g, 35.6 mmol) was added to the solution at 0° C., the mixture was stirred for 10 minutes. Methanol was added to the reaction solution to quench the reaction and the volatile components were evaporated at 70° C. with a vacuum pump to give poly(1-hexene) (2.76 g, yield 92%). With the stereoselectivity, the resulting poly(1-hexene) had an isoselectivity (mmmm) of 98.7% from ¹³C-NMR data, with Mw=120000 and Mw/Mn=1.6.

### Comparative Example 5

In a 50 mL Schlenk flask, [cyclooctanediyl-trans-1,2-bis(2-oxoyl-3,5-di-tert-butylbenzylsulfanyl)]dibenzylzirconium (1.8 mg, 0.0020 mmol) was dissolved in benzene (1 mL), and then triphenylcarbenium tetrakis(pentafluorophenyl)borate [Ph₃CB(C₆F₅)₄] (1.8 mg, 0.0020 mmol) was added at 25° C. to the solution. The mixture was stirred for 5 minutes. After 1-hexene (3 g, 35.6 mmol) was added to the solution at 25° C., the mixture was stirred for 10 minutes. Methanol was added to the reaction solution to quench the reaction and the volatile components were evaporated at 70° C. with a vacuum pump to give poly(1-hexene) (0.83 g, yield 28%). With the stereoselectivity, the resulting poly(1-hexene) had an isoselectivity (mmmm) of 97.9% from ¹³C-NMR data, with Mw=59000 and Mw/Mn=1.7

### Comparative Example 6

In a 50 mL Schlenk flask, [cyclooctanediyl-trans-1,2-bis(2-oxoyl-3,5-di-tert-butylbenzylsulfanyl)]dibenzylhafnium (18.9 mg, 0.020 mmol) was dissolved in benzene (1 mL) and hexane (5 mL), and then tris(pentafluorophenyl)borane [B(C₆F₅)₃] (10.2 mg, 0.020 mmol) was added at 25° C. to the solution. The mixture was stirred for 5 minutes. After 1-hexene (3 g, 35.6 mmol) was added to the solution at 25° C., the mixture was stirred for 10 minutes. Methanol was added to the reaction solution to quench the reaction and the volatile components were evaporated at 70° C. with a vacuum pump to give poly(1-hexene) (0.03 g, yield 1%). With the stereoselectivity, the resulting poly(1-hexene) had an isoselectivity (mmmm) of 86.2% from ¹³C-NMR data, with Mw=28400 and Mw/Mn=1.9.

### Comparative Example 7

In a 50 mL Schlenk flask, [cyclooctanediyl-trans-1,2-bis(2-oxoyl-3,5-di-tert-butylbenzylsulfanyl)]dibenzylhafnium (18.9 mg, 0.020 mmol) was dissolved in toluene (5 mL), and then triphenylcarbenium tetrakis(pentafluorophenyl)borate [Ph₃CB(C₆F₅)₄] (18.4 mg, 0.020 mmol) was added at 25° C. to the solution. The mixture was stirred for 5 minutes. After 1-hexene (3 g, 35.6 mmol) was added to the solution at 0° C., the mixture was stirred for 15 minutes. Methanol was added to the reaction solution to quench the reaction and the volatile components were evaporated at 70° C. with a vacuum pump to give poly(1-hexene) (0.03 g, yield 1%). With the stereoselectivity, the resulting poly(1-hexene) had an isoselectivity (mmmm) of 88.6% from ¹³C-NMR data, with Mw=56000 and Mw/Mn=1.9.

TABLE 1

| Example & | | Reaction | Reaction | Polymerization | | | |
|---|---|---|---|---|---|---|---|
| Comparative | | Temp. | Time | Activity | | M_{w}/ | |
| Example | Co-catalyst | ° C. | min. | g/mmol⁻¹ · h⁻¹ | M_{w} | Mₙ | [mmmm] % |
| Ex. 1 | B(C₆F₅)₃ | 25 | 10 | 186 | 120000 | 1.3 | 99.3 |
| Ex. 2 | B(C₆F₅)₃ | 25 | 20 | 180 | 185000 | 1.5 | 98.9 |
| Ex. 3 | B(C₆F₅)₃ | 25 | 30 | 216 | 227000 | 1.7 | 97.0 |
| Ex. 4 | B(C₆F₅)₃ | 25 | 4 | 218 | 100000 | 1.3 | 99.2 |
| Ex. 5 | B(C₆F₅)₃ | 25 | 7 | 407 | 170000 | 1.5 | 99.3 |
| Ex. 6 | B(C₆F₅)₃ | 25 | 10 | 606 | 191000 | 1.8 | 98.9 |
| Ex. 7 | Ph₃CB(C₆F₅)₄ | 0 | 15 | 152 | 256000 | 1.5 | 98.2 |
| Ex. 8 | Ph₃CB(C₆F₅)₄ | 0 | 30 | 220 | 421000 | 1.6 | 99.7 |
| Comp. Ex. 1 | B(C₆F₅)₃ | 25 | 5 | 1610 | 43000 | 1.9 | 95.3 |
| Comp. Ex. 2 | B(C₆F₅)₃ | 25 | 10 | 850 | 43000 | 1.9 | 97.6 |
| Comp. Ex. 3 | Ph₃CB(C₆F₅)₄ | 25 | 10 | 870 | 41000 | 2.1 | 97.4 |
| Comp. Ex. 4 | Ph₃CB(C₆F₅)₄ | 0 | 10 | 830 | 120000 | 1.6 | 98.7 |
| Comp. Ex. 5 | Ph₃CB(C₆F₅)₄ | 25 | 10 | 2500 | 59000 | 1.7 | 97.9 |
| Comp. Ex. 6 | B(C₆F₅)₃ | 25 | 10 | 9 | 28400 | 1.9 | 86.2 |
| Comp. Ex. 7 | Ph₃CB(C₆F₅)₄ | 0 | 15 | 6 | 56000 | 1.9 | 88.6 |

Table 2 summarizes the experimantal conditions and the observed molecular weights of poly(4-methyl-1-pentene) products.

The following experiments were carried out in an argon atmosphere in a glove box, and the molecular weights were determined in accordance with <Condition 2 for measurement of molecular weight> and the tacticity was determined in accordance with <Condition 2 for measurement of tacticity> and <Calculation procedure 2>.

### Example 9

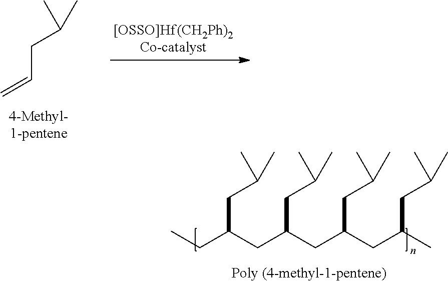

In a 50 mL Schlenk flask, [cyclooctanediyl-trans-1,2-bis(2-oxoyl-3,5-di-tert-butylbenzylsulfanyl)]dibenzylhafnium (19.4 mg, 0.020 mmol) was dissolved in benzene (1 mL) and hexane (5 mL), and then tris(pentafluorophenyl)borane [B(C₆F₅)₃] (10.2 mg, 0.020 mmol) was added at 25° C. to the solution. The mixture was stirred for 5 minutes. After 4-methyl-1-pentene (3 g, 35.6 mmol) was added to the solution at 25° C., the mixture was stirred for 5 minutes. Methanol was added to the reaction solution to quench the reaction and the white solid was filtered off and was dried at 70° C. under vacuum to give poly(4-methyl-1-pentene) (0.09 g, 3%). The ¹³C-NMR analysis of the resulting poly(4-methyl-1-pentene) gave no detectable spectra other than those showing isoselectivity (mmmm).

### Example 10

In a 50 mL Schlenk flask, [cyclooctanediyl-trans-1,2-bis(2-oxoyl-3,5-di-tert-butylbenzylsulfanyl)]dibenzylhafnium (19.4 mg, 0.020 mmol) was dissolved in benzene (1 mL) and hexane (5 mL), and then triphenylcarbenium tetrakis(pentafluorophenyl)borate [Ph₃CB(C₆F₅)₄] (18.4 mg, 0.020 mmol) was added at 25° C. to the solution. The mixture was stirred for 5 minutes. After 4-methyl-1-pentene (3 g, 35.6 mmol) was added to the solution at 25° C., the mixture was stirred for 5 minutes. Methanol was added to the reaction solution to quench the reaction and the white solid was filtered off and was dried at 70° C. under vacuum to give poly(4-methyl-1-pentene) (0.21 g, 7%). The ¹³C-NMR analysis of the resulting poly(4-methyl-1-pentene) gave no detectable spectra other than those showing isoselectivity (mmmm).

### Example 11

In a 50 mL Schlenk flask, [cyclooctanediyl-trans-1,2-bis(2-oxoyl-3,5-di-tert-butylbenzylsulfanyl)]dibenzylhafnium (19.4 mg, 0.020 mmol) was dissolved in toluene (5 mL), and then triphenylcarbeniurn tetrakis(pentafluorophenyl)borate [Ph₃CB(C₆F₅)₄] was added at 25° C. to the solution. The mixture was stirred for 5 minutes. After 4-methyl-1-pentene (1 g, 11.9 mmol) was added to the solution at 25° C., the mixture was stirred for 10 minutes. Methanol was added to the reaction solution to quench the reaction and the white solid was filtered off and was dried at 70° C. under vacuum to give poly(4-methyl-1-pentene) (0. 10 g, 10%). The ¹³C-NMR analysis of the resulting poly(4-methyl-1-pentene) gave no detectable spectra other than those showing isoselectivity (mmmm).

### Example 12

In a 50 mL Schlenk flask, [cyclooctanediyl-trans-1,2-bis(2-oxoyl-3,5-di-tert-butylbenzylsulfanyl)]dibenzylhafnium (19.4 mg, 0.020 mmol) was dissolved in dichloromethane (5 mL), and then triphenylcarbenium tetrakis(pentafluorophenyl)borate [Ph₃CB(C₆F₅)₄] was added at 25° C. to the solution. The mixture was stirred for 10 minutes. After 4-methyl-1-pentene (1.0 g, 11.9 mmol) was added to the solution at 25° C., the mixture was stirred for 5 minutes. Methanol was added to the reaction solution to quench the reaction and the white solid was filtered off and was dried at 70° C. under vacuum to give poly(4-methyl-1-pentene) (0.34 g, 34%). The ¹³C-NMR analysis of the resulting poly(4-methyl-1-pentene) gave no detectable spectra other than those showing isoselectivity (mmmm).

TABLE 2

| Example & | | Reaction | Reaction | Polymerization | | |
|---|---|---|---|---|---|---|
| Comparative | | Temp. | Time | Activity | | |
| Example | Co-catalyst | ° C. | min. | g/mmol⁻¹ · h⁻¹ | M_{w} | M_{w}/Mₙ |
| Ex. 9 | B(C₆F₅)₃ | 25 | 5 | 54 | 51000 | 1.5 |
| Ex. 10 | Ph₃CB(C₆F₅)₄ | 25 | 5 | 126 | 61000 | 2.5 |
| Ex. 11 | Ph₃CB(C₆F₅)₄ | 25 | 10 | 30 | 7300 | 1.3 |
| Ex. 12 | Ph₃CB(C₆F₅)₄ | 25 | 5 | 101 | 44000 | 2.0 |

Each item in Examples 13 to 21 and Comparative Example 8 was measured by the following procedures.
(1) Melting Point

The melting point was determined with a thermal analyzer: a differential scanning calorimeter (Diamond DSC manufactured by Perkin Elmer Inc.) through the following procedure:
1) Being held about 10 mg of a sample at 220° C. for 5 minutes in nitrogen atmosphere,
2) Being cooled the sample from 150° C. to 50° C. (at 5° C./min), and retained at 50° C. for 1 minute.
3) Being heated the sample from 50° C. to 180° C. (at 5° C./min).
(2) Molecular Weight and Molecular Weight Distribution

These values were measured by gel permeation chromatography (GPC) under the following conditions. A calibration curve was determined using standard polystyrene samples. The molecular weight distribution was evaluated with the ratio (Mw/Mn) of the weight-average molecular weight (Mw) to the number-average molecular weight (Mn).

Apparatus: type 150C, manufactured by Millipore Waters Co.

Columns: TSK-GEL GMH-HT 7.5×600 two columns

Measuring temperature: 152° C.

Solvent: ortho-dichlorobenzene

Concentration: 5 mg/5 mL
(3) Isotactic pentad fraction ([mmmm])

The isotactic pentad fraction refers to the fraction of propylene monomer units present in the centers of isotactic linkages expressed in pentad units in a crystalline polypropylene molecular chain, in other words, linkages each consisting of five continuously meso-bonded propylene monomer units which fraction is measured by ¹³C-NMR spectroscopy in accordance with the procedure disclosed in A. Zambelli et al., Macromolecules, Vol.6, 925 (1973). In a 10-mmcl) test tube, a polymer (about 200 mg) was dissolved homogeneously in ortho-dichlorobenzene (3 mL) to prepare a sample which was then analyzed by ¹³C-NMR spectroscopy. The NMR spectroscopy was carried out with an apparatus AVANCE600 manufactured by Bruker Corp. under the following conditions: Absorption peaks in an NMR spectrum were assigned in accordance with the description of F. A. Bovey et al. Macromolecules Vol. 8, 687 (1975).

Measuring Temperature: 135° C.

Pulse Repetition Time: 10 seconds

Pulse Width: 45°

Cumulated Number: 2500 times
(4) Intrinsic Viscosity (N) (unit: dl/g)

The intrinsic viscosity was measured with an Ubbellohde viscometer using tetralin as a solvent at 135° C.

### Reference Example 7

Method for Preparing d-MAO

PMAO-S in toluene (aluminum content:6.1 wt %, manufactured by Tosoh Finechem Corp.) was measured out with a 100 mL syringe, and was placed into a nitrogen-purged 200 mL two-necked flask with a three-way cock and a stirrer bar. The solution was evacuated so that the volatile components were removed. The resulting white solid was dissolved in dehydrated toluene (100 mL), and then the volatile components were removed under reduced pressure. This procedure was repeated two more times to give a white powder (14.1 g).

### Reference Example 8

Method for Preparing d-MMAO-3A

Reference Example 8 was carried out as in Reference Example 7 except that MMAO-3A in toluene (aluminum content: 7.0 wt %, manufactured by Tosoh Finechem Corp.) was used in place of PMAO-S in toluene (aluminum content:6.1 wt %, manufactured by Tosoh Finechem Corp.)

### Reference Example 9

Method for Preparing d-MMAO-4

Reference Example 9 was carried out as in Reference Example 7 except that MMAO-4 in toluene (aluminum content: 7.4 wt %, manufactured by Tosoh Finechem Corp) was used in place of PMAO-S in toluene (aluminum content:6.1 wt %, manufactured by Tosoh Finechem Corp.)

### Example 13

A stirrer-equipped autoclave (internal volume 400 mL) was dried under vacuum, purged with argon, and charged with toluene (40 mL) as a solvent and propylene (80 g) as a monomer. After the reactor was cooled to 0° C., d-MAO (118 mg) and then [cyclooctanediyl-trans-1,2-bis(2-oxoyl-3,5-di-tert-butylbenzylsulfanyl)]dibenzylhafnium (1 μmol/mL, toluene solution) (1 mL, 1.0 μmol) were added to initiate polymerization. Polymerization was carried out for 60 minutes while the temperature was maintained at 0° C. to give polypropylene (0.5 g), with polymerization activity=5.0×10⁵ g/mol, melting point=156.2° C., Mw=50400, Mw/Mn=2.1, and [mmmm]=93.7%.

### Example 14

Example 14 was carried out as in Example 13 except that the polymerization temperature was 14° C.

### Example 15

Example 15 was carried out as in Example 13 except that the polymerization temperature was 40° C.

### Example 16

Example 16 was carried out as in Example 13 except that the polymerization temperature was 70° C.

### Example 17

Example 17 was carried out as in Example 13 except that d-MAO was replaced with d-MMAO-3A and the polymerization temperature was 40° C.

### Example 18

Example 18 was carried out as in Example 13 except that d-MAO was replaced with d-MMAO-4 and the polymerization temperature was 40° C.

### Example 19

A stirrer-equipped autoclave (internal volume 400 mL) was dried under vacuum, purged with argon, and charged with toluene (40 mL) as a solvent and propylene (80 g) as a monomer. After the reactor was cooled to 0° C., d-MAO (118 mg) and then [cyclooctanediyl-trans-1,2-bis(2-oxoyl-3,5-di-tert-butylbenzylsulfanyl)]dichlorohafnium (0.33 μmol/mL, toluene solution) (1.5 mL, 0.5 μmol) were added to initiate polymerization. Polymerization was carried out for 60 minutes while the temperature was maintained at 70° C. to give polypropylene (11.3 g), with polymerization activity=2.3×10⁷ g/mol, melting point=139.7° C., Mw=16500, Mw/Mn=2.3, [mmmm]=85.4%, and [η]=0.22.

### Comparative Example 8

A stirrer-equipped autoclave (internal volume 400 mL) was dried under vacuum, purged with argon, and charged with toluene (40 mL) as a solvent and propylene (80 g) as a monomer. After the reactor was heated to 40° C., d-MAO (118 mg) and then [cyclooctanediyl-trans-1,2-bis(2-oxoyl-3,5-di-tert-butylbenzylsulfanyl)]dibenzylhafnium (0.456 μmol/mL, toluene solution) (1.1 mL, 0.50 μmol) were added to initiate polymerization. Polymerization was carried out for 60 minutes while the temperature was maintained at 40° C. to give polypropylene (1.5 g), with polymerization activity=3.0×10⁶ g/mol, melting point=76.9° C., Mw=6900, Mw/Mn=1.7, [mmmm]=40.5%, and [η]=0.12.

### Example 20

A stirrer-equipped autoclave (internal volume 400 mL) was dried under vacuum, purged with argon, and charged with toluene (40 mL) as a solvent and propylene (80 g) as a monomer. After the reactor was heated to 40° C., triisobutylaluminum (1.0 mol/L, toluene solution) (0.5 mL, 0.5 mmol), [cyclooctanediyl-trans-1,2-bis(2-oxoyl-3,5-di-tert-butylbenzylsulfanyl)]dibenzylhafnium (1.85 μmol/mL, toluene solution) (2.7 mL, 5.00 μmol), and triphenylcarbenium tetrakis(pentafluorophenyl)borate (4.0 μmol/m L, toluene solution) (6.25 mL, 25.00 μmol) were added in turn to initiate polymerization. Polymerization was carried out for 60 minutes while the temperature was maintained at 40° C. to give polypropylene (17.1 g), with polymerization activity =3.4×10⁶ g/mol, melting point=148.5° C., Mw=31900, Mw/Mn=2.4, [mmmm]=90.9%, and [η]=0.36.

### Example 21

A stirrer-equipped autoclave (internal volume 400 mL) was dried under vacuum, purged with argon, and charged with toluene (40 mL) as a solvent and propylene (80 g) as a monomer. After the reactor was heated to 40° C., triisobutylaluminum (1.0 mol/L, toluene solution) (0.5 mL, 0.5 mmol), [cyclooctanediyl-trans-1,2-bis(2-oxoyl-3,5-di-tert-butylbenzylsulfanyl)]dichlorohafnium (0.33 μmol/mL, toluene solution) (3.0 mL, 1.00 μmol), and triphenylcarbenium tetrakis(pentafluorophenyl)borate (4.0 μmol/mL, toluene solution) (1.25 mL, 5.00 μmol) were added in turn to initiate polymerization. Polymerization was carried out for 60 minutes while the temperature was maintained at 40° C. to give polypropylene (2.6 g), with polymerization activity=2.6×10⁶ g/mol, melting point=140.0° C., Mw=11800, Mw/Mn=2.2, [mmmm]=86.4%, and [η]=0.18.

Table 3 shows the results of polymerization in Examples 13 to 21 and Comparative Example 8.

TABLE 3

| Example & | | Polymerization | Melting | | | | | | |
|---|---|---|---|---|---|---|---|---|---|
| Comparative | | Activity | Point | | | | 2,1- | [η] | 1,3- |
| Example | yield g | g/mol | ° C. | M_{w} | M_{w}/Mₙ | [mmmm] % | insertion % | dl/g | insertion % |
| Ex. 13 | 0.50 | 5.0 × 10⁵ | 156.2 | 50400 | 2.1 | 93.7 | 0 | — | 0 |
| Ex. 14 | 0.33 | 3.3 × 10⁵ | 153.0 | 48800 | 1.9 | 93.0 | 0.04 | — | 0 |
| Ex. 15 | 2.00 | 2.0 × 10⁶ | 149.3 | 27000 | 2.0 | 91.0 | 0.07 | — | 0 |
| Ex. 16 | 16.9 | 1.7 × 10⁷ | 140.9 | 26300 | 2.0 | 86.8 | 0.12 | — | 0 |
| Ex. 17 | 0.28 | 1.4 × 10⁵ | 155.8 | 74700 | 2.0 | 94.9 | 0 | — | 0 |
| Ex. 18 | 0.38 | 1.9 × 10⁵ | 156.4 | 88200 | 2.2 | 92.4 | 0.01 | — | 0 |
| Ex. 19 | 11.3 | 2.3 × 10⁷ | 139.7 | 16500 | 2.3 | 85.4 | 0.04 | 0.22 | 0 |
| Comp. Ex. 8 | 1.5 | 3.0 × 10⁶ | 76.9 | 6900 | 1.7 | 40.5 | 0.25 | 0.12 | 0.21 |
| Ex. 20 | 17.1 | 3.4 × 10⁶ | 148.5 | 31900 | 2.4 | 90.9 | 0.07 | 0.36 | 0 |
| Ex. 21 | 2.6 | 2.6 × 10⁶ | 140.0 | 11800 | 2.2 | 86.4 | 0.20 | 0.18 | 0 |

### Example 22

Example 22 was carried out as in Example 13 except that the amount of the hafnium complex was 5.0 μmol, the polymerization temperature was 40 ° C., and the monomer was 1-butene. The polymerization gave polybutene (20.0 g), with polymerization activity=4.0×10⁶ g/mol, melting point=107.0° C., Aw=4190, Mw/Mn=2.2, and [mmmm]=96.0%.

### Example 23

A stirrer-equipped autoclave (internal volume 400 mL) was dried under vacuum, purged with argon, and charged with toluene (40 mL) as a solvent and 1-butene (80 g) as a monomer. After the reactor was heated to 40° C., triisobutylaluminum (1.0 mol/L, toluene solution) (0.5 mL, 0.5 mmol), [cyclooctanediyl-trans-1,2-bis(2-oxoyl-3,5-di-tert-butylbenzylsulfanyl)]dibenzylhafnium (1.85 μmol/mL, toluene solution) (2.7 mL, 5.00 μmol), and triphenylcarbenium tetrakis(pentafluorophenyl)borate (4.0 μmol/m L, toluene solution) (6.25 mL, 25.00 μmol) were added in turn to initiate polymerization. Polymerization was carried out for 60 minutes while the temperature was maintained at 40° C. to give polybutene (7.7 g), with polymerization activity=1.5×10⁶ g/mol, melting point=107.7° C., Aw=1900, Mw/Mn=2.0, [η]=0.45, and [mmmm]=96.1%.

### INDUSTRIAL APPLICABILITY

The present invention is useful in the field related to the production of the stereoselective polyolefin.

1. A stereoselective olefin polymerization catalyst comprising a complex represented by Formula (1): 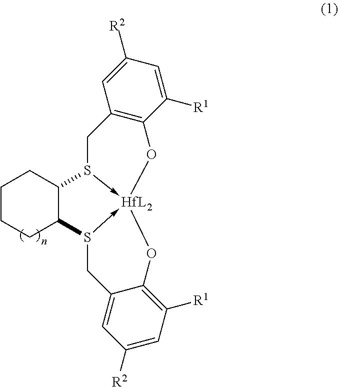
wherein n is 2 or 3;
R¹ and R² are independently an optionally substituted alkyl group or a halogen atom;
L is a ligand represented by CH₂R³, a halogen atom, OR⁴, or NR⁵R⁶;
R³ is a hydrogen atom, an aromatic group, or a trialkylsilyl group;
R⁴ is a lower alkyl group having 1 to 6 carbon atoms; and
R⁵ and R⁶ are independently a hydrogen atom or a lower alkyl group having 1 to 6 carbon atoms.

2. The catalyst according to claim 1, wherein n is 3.

3. The catalyst according to claim 1, wherein R¹ and R² are independently an optionally substituted alkyl group having 1 to 30 carbon atoms.

4. The catalyst according to claim 1, further comprising a boron compound or an organoaluminum compound as a co-catalyst.

5. The catalyst according to claim 4, wherein the boron compound is represented by BR¹¹R¹²R¹³, W⁺(BR¹¹R¹²R¹³R¹⁴)⁻, or (V—H)⁺(BR¹¹R¹²R¹³R¹⁴)⁻,
wherein R¹¹ to R¹⁴ are a halogen atom, a hydrocarbyl group having 1 to 20 carbon atoms, a halogenated hydrocarbyl group having 1 to 20 carbon atoms, a substituted silyl group having 1 to 20 carbon atoms, an alkoxy group having 1 to 20 carbon atoms, or a disubstituted amino group having 2 to 20 carbon atoms;
where R¹¹ to R¹⁴ may be the same or different;
W⁺ is an inorganic or organic cation;
V is a neutral Lewis base; and
(V—H)⁺ is a Broensted acid.

6. The catalyst according to claim 4, wherein the organoaluminum compound is a cyclic aluminoxane and/or a linear aluminoxane.

7. A method for manufacturing stereoselective polyolefin, comprising polymerizing an olefin in the presence of the catalyst according to claim 1.

8. The method according to claim 7, wherein the olefin is a monoolefin or a diolefin.

9. The method according to claim 8, wherein the monoolefin is at least one olefin selected from the group consisting of propylene, 1-butene, 1-pentene, 1-hexene, and 4-methyl-1-pentene.

10. The method according to claim 8, wherein the diolefin is at least one olefin selected from the group consisting of butadiene, 1,5-hexadiene, and 1,6-heptadiene.
